(19) United States
(12) Patent Application Publication
(10) Pub. No.: US 2024/0076478 A1
(43) Pub. Date: Mar. 7, 2024

(54) BIOPLASTIC MATERIALS OBTAINED FROM BIOLOGICAL MATTER

(71) Applicant: University of Washington, Seattle, WA (US)

(72) Inventors: Eleftheria Roumeli, Seattle, WA (US); Ian Campbell, Seattle, WA (US); Andrew M. Jimenez, Seattle, WA (US); Michael Holden, Seattle, WA (US); Paul Grandgeorge, Seattle, WA (US); Kuotian Liao, Seattle, WA (US); Hareesh Iyer, Seattle, WA (US)

(73) Assignee: University of Washington, Seattle, WA (US)

(21) Appl. No.: 18/453,178

(22) Filed: Aug. 21, 2023

Related U.S. Application Data
(60) Provisional application No. 63/373,437, filed on Aug. 24, 2022.

(51) Int. Cl. C08L 5/00; C08J 3/00; C08L 1/02

(52) U.S. Cl. CPC C08L 5/00; C08J 3/005; C08L 1/02; C08J 2301/02; C08J 2305/00; C08J 2405/00; C08L 2201/06

(57) ABSTRACT

Bioplastic compositions and methods of making are described herein. The various mechanical and physical properties of the bioplastic may be varied by altering the thermoforming or incorporating an additive depending on the desired mechanical and physical properties of the end product. The bioplastic may be made entirely of biomatter and be backyard compostable.

### CROSS-REFERENCE TO RELATED APPLICATION

This application claims benefit of U.S. Provisional Patent App. No. 63/373,437, filed on Aug. 24, 2022, which is incorporated by reference herein in its entirety.

### BACKGROUND

Since the 1950s, 8.3 billion tonnes (Bt) of virgin plastics have been produced, of which about 5 Bt have accumulated as waste in natural environments, posing severe threats to the entire ecosystem. With the total amount of petrochemical-based plastics produced by 2050 predicted to be 33 billion tons, compared to 0.28 billion tons in 2012 (I. Campbell and M.-Y. Lin et. al., Annu. Rev. Mater. Res. 2023, 53), the need for sustainable bio-based alternatives to traditional petroleum derived plastics is evident.

The chemical stability of common plastics makes them attractive for numerous applications, but is also responsible for slow degradation rates, which allow them to permeate the environment (X. Zhang, et al., Chem. Rev. 2018, 118, 839). During the long degradation timeframes, plastics are fragmented into microplastics that can seep into food and water systems at all levels of the food chain, causing health hazards throughout the environment (C. M. Rochman, et al. Nature, 2013, 494, 169).

Current bioplastics such as polylactic acid (PLA) and poly(hydrozyalkanoate) (PHA), have the potential to reduce petroleum dependency and plastic pollution. However, scalability challenges and economic feasibility limit the range of applications for these bioplastics. Other bioplastics suffer from similar issues. For example, thermoplastic starch has a relatively low strength of less than 6 MPa (K. M. Dang, et al., Carbohydr. Polym 2020, 242, 116392). Lingocellulosic polymers provide materials with a higher strength than thermoplastic starch, but the extraction of cellulose from biomass involves multi-step processes and harsh chemicals, and therefore does not address the ongoing environmental concerns of plastic production and use (G. Tedeschi, et. Al., Biomacromolecules, 2020, 21, 910).

Microalgae holds interest as a potential source for bioplastics, as microalgae capture around 1.8 kg CO₂ per kg of dry biomass, providing an ecological advantage over fuel-derived polymers. For comparison, the global warming potential of 1 kg of high-density polyethylene pellets was reported to be 1.9 kg CO₂ by PlasticsEurope, while polypropylene was reported to have a GWP of 2.0 kg CO₂. In 2019, a cradle-to-gate study showed the GWP of Corbion PLA pellets to be 0.501 kg CO₂ per kg of PLA. However, as of yet, microalgae have not yielded promising results as heated compression of Arthrospira platensis (spirulina) and Chlorella vulgaris (chlorella) show poor tensile strengths of 5.7 and 3.0 MPa, respectively (M. A. Zeller, et al., J. Appl. Polym. Sci. 2013, 130, 3263).

In an effort to overcome the drawbacks of biodegradable plastics, recent studies have attempted to introduce biologically based materials as fillers in common plastic matrices, thus minimizing the use of non-renewable materials. However, the poor bonding between plant-based biomatters and common plastics often leads to mechanical weakening of the produced bioplastics. Further, the heavy use of chemical additives and multi-step processing necessary to circumvent these bonding obstacles has rendered the manufacturability of this filler-based strategy challenging.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-D provide (FIG. 1A) a graph of the composition of spirulina (Fredericks, J, et al. Spirulina-based composites for 3D printing. J. Poly Sci (2021) (Prior Art), transmission electron microscope (TEM) image of spirulina at (FIG. 1B) 2 μm, (FIG. 1C) 10 μm, and (FIG. 1D) 50 nm.

FIG. 2 is a comparison of the bending/flexural modulus of biomatter materials including spirulina plastics, where “spirulina plastics” include pure spirulina and compositions containing 70% spirulina and 30% additives.

FIGS. 3A-C illustrate the effect of sonication on spirulina with (FIG. 3A) a graph showing substantial particle size reduction from 28.3±16.6 to 5.5±3.5 μm, (FIG. 3B) scanning electron microscope (SEM) image of unprocessed spirulina at 50 μm, and (FIG. 3C) SEM image of sonicated spirulina at 50 μm.

FIGS. 4A-B are SEM images of (FIG. 4A) the weakest spirulina bioplastic (produced using 60° C., 7 kN, for 5 min) and (FIG. 4B) the strongest spirulina plastic (produced using 140° C., 7 kN, for 5 min).

FIG. 5 is a graph showing infrared spectroscopy of spirulina powder, poorly-bonded bioplastic (produced using 60° C. 7 kN, 5 min), and well-bonded bioplastic (produced using 140° C., 7 kN, 5 min).

FIGS. 6A-C are graphs comparing area percentage numbers for the C—C/C—H, C—O/C—N, and C═O peaks as deconvoluted from the C1s spectra for (FIG. 6A) well-bonded spirulina, (FIG. 6B) poorly-bonded spirulina, and (FIG. 6C) spirulina powder.

FIG. 7 is C1s spectra for well-bonded spirulina, poorly-bonded spirulina, and spirulina powder.

FIGS. 8A-C are the results of thermogravimetric analysis (TGA) of a well-pressed, well-self-bonded sample and spirulina powder showing (FIG. 8A) mass loss due to temperature, (FIG. 8B) first derivative of mass loss over time and (FIG. 8C) the mass loss of spirulina powder at lower temperatures.

FIGS. 9A-B are graphs of (FIG. 9A) flexural strength versus pressing temperature for a fixed pressing force (7 kN) and (FIG. 9B) strength versus time with a plateau in strength at approximately 5 minutes.

FIGS. 10A-B are graphs of (FIG. 10A) representative stress-strain curves for spirulina at different pressing times and (FIG. 10B) flexural strength of spirulina bioplastics with varying pressing times.

FIGS. 11A-B are graphs showing the effects of (FIG. 11A) strength vs. temperature at different pressures and (FIG. 11B) strength vs. pressing force at various temperatures.

FIG. 12 is a heat map of flexural strength for spirulina bioplastics at each temperature/pressure.

FIGS. 13A-C are graphs of (FIG. 13A) density vs. pressing force at different temperatures, (FIG. 13B) density vs. temperature at different pressing forces, and (FIG. 13C) strength vs. density.

FIGS. 14A-B are graphs of (FIG. 14A) flexural modulus vs temperature at different pressures and (FIG. 14B) flexural modulus vs pressure at different temperatures.

FIGS. 15A-B are graphs of (FIG. 15A) toughness vs temperature at various pressing forces and (FIG. 15B) toughness vs pressing force at various temperatures.

FIGS. 16A-D are box plots of (FIG. 16A) reduced modulus at different temperature/pressure/time and effects of temperature on self-bonded spirulina with regard to (FIG. 16B) flexural stiffness, (FIG. 16C) strength and (FIG. 16D) toughness, with bending strength and toughness optimized at 135/1/1.

FIGS. 17A-B are Ashby plots comparing (FIG. 16A) the strength and (FIG. 16B) the moduli of the reported bioplastics where “spirulina bioplastics” includes pure spirulina and spirulina composites including 70% spirulina in comparison with natural materials, synthetic plastics, and polylactic acid (PLA).

FIGS. 18A-C are SEM images at 100 μm of spirulina bioplastics with (FIG. 18A) 0% sorbitol, (FIG. 18B) 10% sorbitol, and (FIG. 18C) 30% sorbitol.

FIGS. 19A-D are box plots showing the changes in (FIG. 19A) flexural stiffness, (FIG. 19B) strength, (FIG. 19C) toughness at increasing sorbitol concentrations, and (FIG. 19D) representative stress-strain curves of the spirulina/sorbitol bioplastics.

FIGS. 20A-B are SEM images of (FIG. 20A) spirulina/nanoclay and (FIG. 20B) spirulina/bacterial cellulose composites.

FIGS. 21A-B are (FIG. 21A) representative stress-strain curves of bioplastics made of pure spirulina, sonicated spirulina, sonicated spirulina with nanoclay and sonicated spirulina with bacterial cellulose formed using T=140° C., pressing force=35 kN, for 5 min; and (FIG. 21B) effects of sonication and fillers on the toughness of bioplastics made of pure spirulina, sonicated spirulina, sonicated spirulina with nanoclay and sonicated spirulina with bacterial cellulose.

FIG. 22 is a series of images showing the flammability of spirulina at different time points in comparison to PLA.

FIG. 23 is a series of images comparing the flammability of spirulina (CS) with varying amounts of bacterial cellulose (BC).

FIG. 24 is a graph depicting flexural strength values for regenerated spirulina samples.

FIGS. 25A-C are (FIG. 25A) photograph of biodegradation of spirulina plastics at day 1, (FIG. 25B) photograph of biodegradation of spirulina bioplastics at day 111, and (FIG. 25C) a graph of the percentage of degradation of spirulina bioplastic vs. time.

FIG. 26 is a comparison of the rate of biodegradation between PLA, banana peel, and spirulina.

### DETAILED DESCRIPTION

Various implementations described herein relate to bioplastics and methods of manufacturing bioplastics from biomatter. The mechanical and physical properties of the bioplastics may be varied depending on composition and manufacturing conditions. In some examples the bioplastics may be made of a single biomatter source such as spirulina. In other aspects, the bioplastics may be made of a combination of biomatter sources such as spirulina and sorbitol. In other aspects, biomatter may be used with a filler or as a filler with existing plastics.

In particular embodiments, the biomatter may be used without extraction or chemical modification. In other embodiments, the biomatter may be pre-treated prior to self-bonding. In some examples the bioplastics are backyard compostables, losing their mass at a rate comparable to other backyard compostables such as fruits or plant matter. In some examples the bioplastics may also be biodegradable, in that they can be metabolized by microorganisms present in the environment that the bioplastics are disposed of. Microorganism degradation entails metabolic conversion of the carbon in bioplastics to gases (CO₂ and or CO₂+CH₄) over time. In some aspects, the compostable products as described here may degrade at rates similar to food waste of the same surface area.

Biomatter may be obtained from any number of sources including algal, and non-algal biomatter. Exemplary algal biomatter sources include Arthrospira sp. (aka. spirulina); Chlorella sp. (subspecies: vulgaris); Ulva sp. (subspecies: expansa, lactuca, etc.); Saccharina latissima (sugar kelp); agarophyton; sargassum; Gracilaria parvispora; Halymenia hawaiiana; and Caulerpa lentillifera. Exemplary non-algal biomatter sources include proteins (including gluten, lactalbumin, bovine serum albumin BSA); lignin; cellulose (including bacterial cellulose fibers, nanocellulose, cellulose nanocrystals, cellulose nanofibers, alpha cellulose, carboxymethylcellulose); hemicellulose (including xylan, glucomannan); other carbohydrates (including starch, isomalt, sucrose); powdered wood from Douglas fir; agai; coffee beans; dragon fruit; matcha powder. The biomatter may include monomers, polymers, cells, tissues, or dissociated cells or tissues from a biological organism.

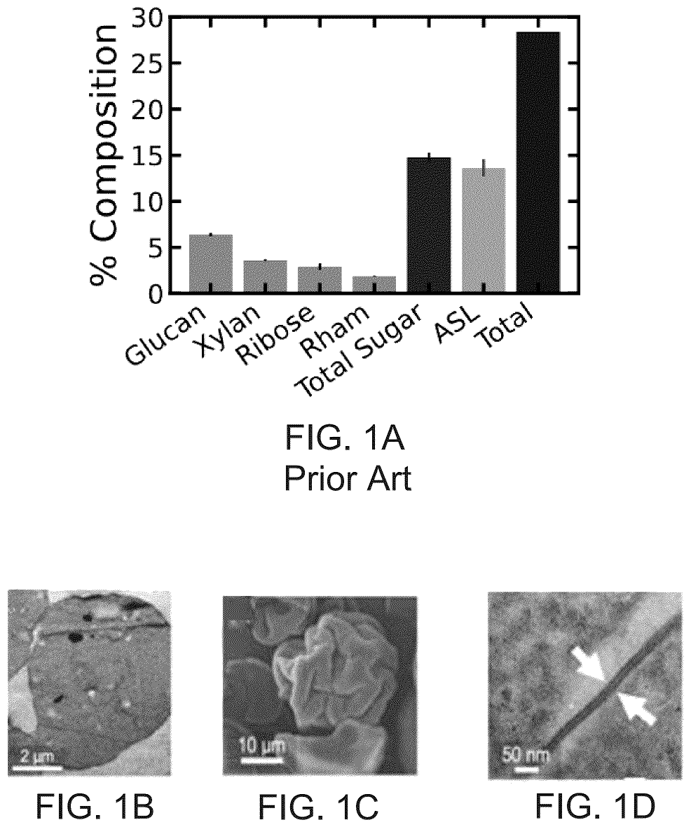

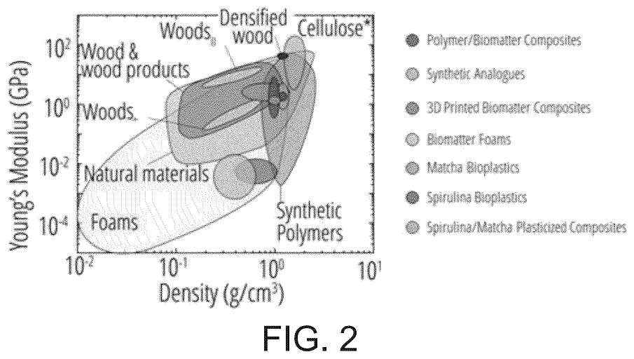

While biomatter may be obtained from any number of sources, algal biomatter, specifically spirulina, is used in particular embodiments. Spirulina is a multicellular, filamentous cyanobacteria with a rapid growth rate in a variety of aquatic environments (Mathiot, C. et al. Microalgae starch-based bioplastics: Screening of ten strains and plasticization of unfractionated microalgae by extrusion. Carbohydrate Polymers 208, 142-151 (2019)). The environmental resilience of algae including spirulina allows for it to be grown close to fabrication facilities, reducing the need for transportation. Further, microalgae may serve as a carbon sink, decreasing the carbon footprint of the manufactured bioplastics. As shown in FIG. 1A, spirulina is peptidoglycan rich with the cells organized in chains as shown in FIGS. 1B-1D. Bioplastics made with pure spirulina and spirulina composites including 70% spirulina demonstrate an elasticity and density comparable or better to many materials currently used including some commodity plastics (FIG. 2).

In various examples, the mechanical and physical properties of biomatter plastics, including spirulina bioplastics, may be altered by combining the biomatter with one or more matrix materials such as proteins (including gluten, lactalbumin, bovine serum albumin (BSA)); lignin; cellulose (including bacterial cellulose fibers, nanocellulose, cellulose nanocrystals, cellulose nanofibers, alpha cellulose, carboxymethylcellulose); hemicellulose (including xylan, glucomannan); and other carbohydrates (including starch, isomalt, sucrose). In various examples, biomatter plastics including spirulina bioplastics may be combined with fillers such as small (e.g., low molecular weight) sugars/carbohydrates (e.g., oligomers consisting of 3-10 monosaccharide units such as polyols like sorbitol, mannitol, glycerol, xylitol); lipids/fatty acids (including stearic acid, oleic acid, linoleic acid, palmitic acid, caprylic acid, lauric acid), carboxylic acids (e.g., monocarboxylic acids (formic acid, acetic acid, propionic acid, butyric acid, valeric acid, caproic acid, enanthic acid, caprylic acid, pelargonic acid, capric acid, lauric acid, myristic acid, palmitic acid, stearic acid, arachidic acid, palmitoleic acid, oleic acid, linoleic acid, linolenic acid, or arachidonic acid) or a dicarboxylic acid (e.g., oxalic acid, malonic acid, succinic acid, glutaric acid, adipic acid, pimelic acid, suberic acid, azelaic acid, sebacic acid, undecanedioic acid, dodecanedioic acid, brassylic acid, thapsic acid, or japanic acid), nanoclays (e.g., montmorillonite, halloysite), nanocellulose, and diatoms. Additional materials that may be combined with the algal materials included viscosity modifiers such as small (low molecular weight) sugars/carbohydrates (polyols like sorbitol, mannitol, glycerol), and lipids/fatty acids (including stearic acid, oleic acid, linoleic acid, palmitic acid, caprylic acid, lauric acid, palm oil) as well as components that enhance electrical conductivity such as graphene, carbon nanotubes (CNTs), carbon fibers, graphite or the magnetic properties of the compositions such as iron oxide particles.

Various bioplastics described herein may additionally be combined with commercial polymers such as polylactic acid (PLA); polybutylene adipate terephthalate (PBAT); polyhydroxyalkanoates (PHAs including copolymers such as poly(3-hydroxybutyrate-co-3-hydroxyvalerate)); Polybutylene succinate (PBS); polyethylene; polypropylene; polystyrene; polycarbonate; and maleic anhydride. In some aspects, the polymers may be biodegradable polymers such as poly(lactic acid) (PLA), polybutylene adipate terephthalate (PBAT), polyethylene oxide (PEO), polycaprolactone (PCL), poly(3-hydroxybutyrate-co-3-hydroxyvalerate) (PHBV), lignin, pine gum, BSA, gluten, casein, lactoglobulin, and/or lysozyme.

The various additives may include 0-99.99 wt % of the composition. In some aspects, the additives may include 0-30 wt % of the composition, including 0%, 10%, 30%, 40%, 45% or fractions thereof. In other aspects, the biomatter may comprise 50% of the bioplastic. The various additives to the biomatter compositions may alter one or more properties of the bioplastic in comparison to pure biomatter bioplastics. For example, a plasticizer such as sorbitol, glycerol, mannitol, xylitol, water, may increase the flexural strength of the bioplastic. In other aspects, the plasticizer may increase the tensile strength of the bioplastic. In some aspects, the plasticizer may increase the facture strain of the bioplastic.

Example biomatter plastics described herein may be used in a variety of consumer and industrial products. In some aspects, the bioplastics described herein may be used as plastic substitutes in a variety of consumer and industrial uses. For example, such bioplastics may be useful in the manufacture of computer peripherals, circuit bords, braille boards, packaging including food packaging, furniture, panels, doors, tarps, household decorative articles, trash bags, toys, fibers, filaments, packaging, foams, medical device packaging, and medical testing devices. In some aspects, the bioplastics described herein may be freeze dried or combined with a blowing agent to form foams.

Various implementations of the present disclosure are directed to improvements in the technological field of bioplastics. Prior bioplastics suffer from issues such as poor tensile strength or toxic production and extraction practices. Earlier bioplastics additionally require high temperature industrial composting facilities to break down and therefore are not readily compostable. In implementations of the present disclosure, algal materials are used to produce strong and stiff backyard-compostable bioplastics.

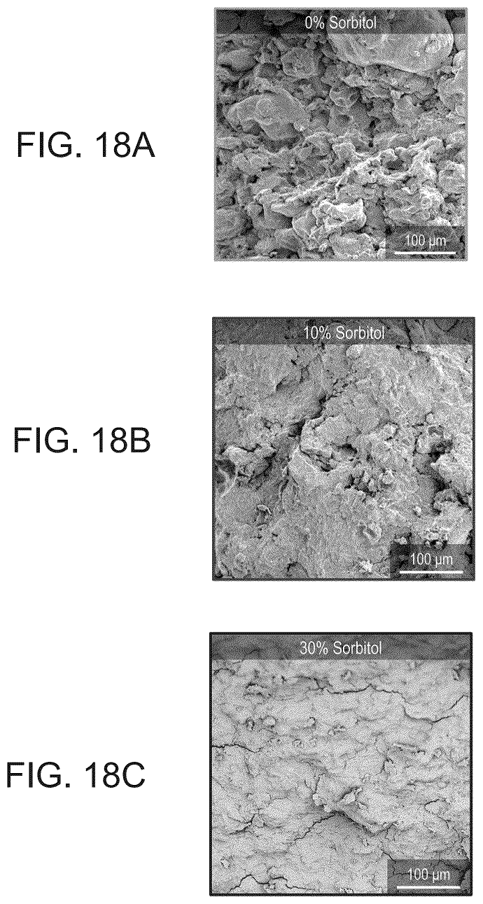

Biomatter plastics as described herein may be manufactured to have various degrees of strength, toughness, flexibility, flammability, and composability depending on the requirements of the end product. For example, furniture may require different strengths, toughness, flexibility, and compostability than food packaging. Further, the mechanical and physical properties of biomatter plastics may be altered though the use of various additives and fillers. For example, as shown in FIGS. 18-24, the addition of nanoclay, sorbitol, and bacterial cellulose conferred different properties on the resulting bioplastics than bioplastics made with spirulina alone.

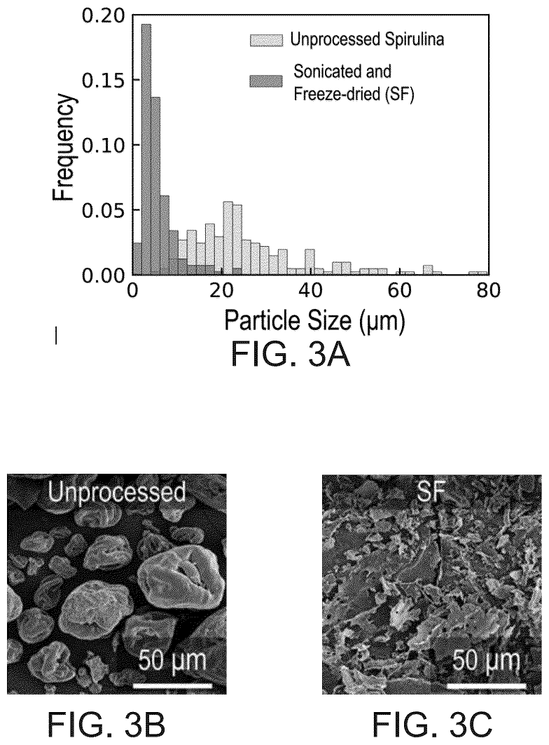

Such biomatter plastics may be formed using a variety of different techniques including, compression molding, extrusion, injection molding, and 3D printing. In some aspects, the biomatter may be pretreated prior to fabrication. For example, it may be ground, sonicated, baked, humidified, and/or freeze-dried. As shown in FIG. 3A, sonicated spirulina results in a much smaller particle size which may improve the self-bonding of the biomatter. In some aspects, pre-treatment may decrease the particle size by 50%, 60%, 70%, 80%, 85%, 90%, 95%, 96% or any fraction thereof.

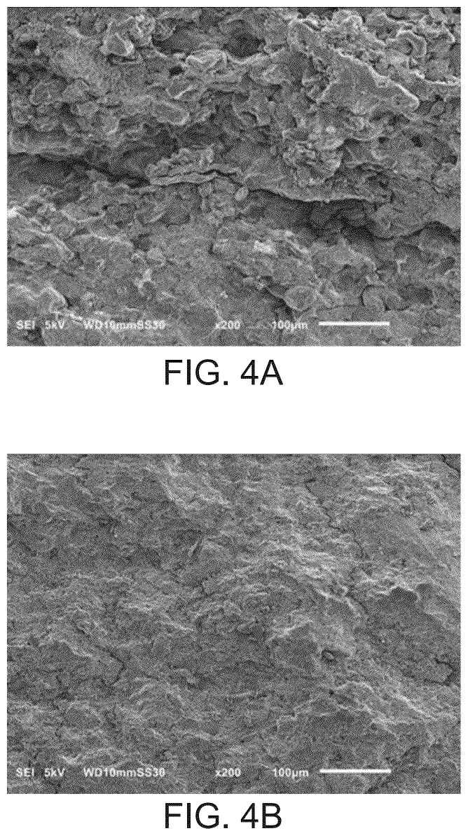

As shown in the SEM images at FIGS. 3B-C, sonication of spirulina results in cellular disruption with unprocessed spirulina powder shown at FIG. 3B and sonicated and freeze-dried spirulina shown at FIG. 3C. In particular embodiments, pre-fabrication steps such as sonication and freeze-drying may result in improved self-bonding as shown in the varying degrees of self-bonding in SEM images of unsonicated spirulina bioplastics prepared at 60 C, 7 kN, 5 minutes (FIG. 4A) and sonicated spirulina bioplastics prepared at 140 C, 7 kN, 5 minutes (FIG. 4B).

In some aspects, various features such as strength, toughness, brittleness, appearance, density, chemical bonding, and compostability of a bioplastic may be manipulated by changing one or more of pre-processing, temperature, time, or pressing force. Such manipulation may allow for bioplastics to have different properties suitable for different end products.

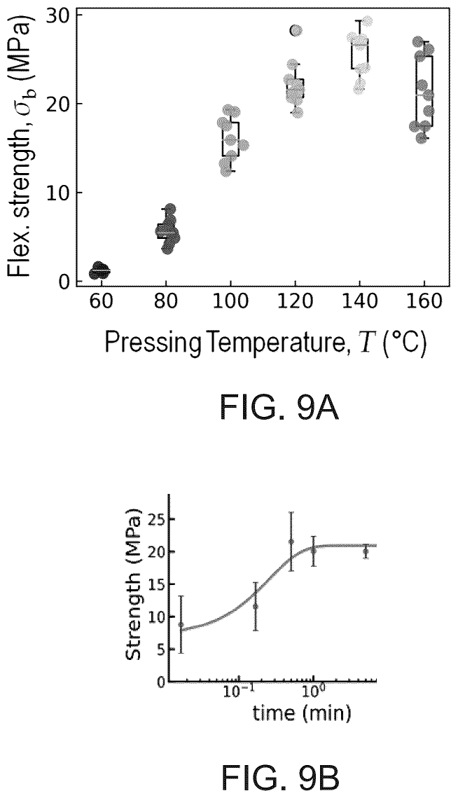

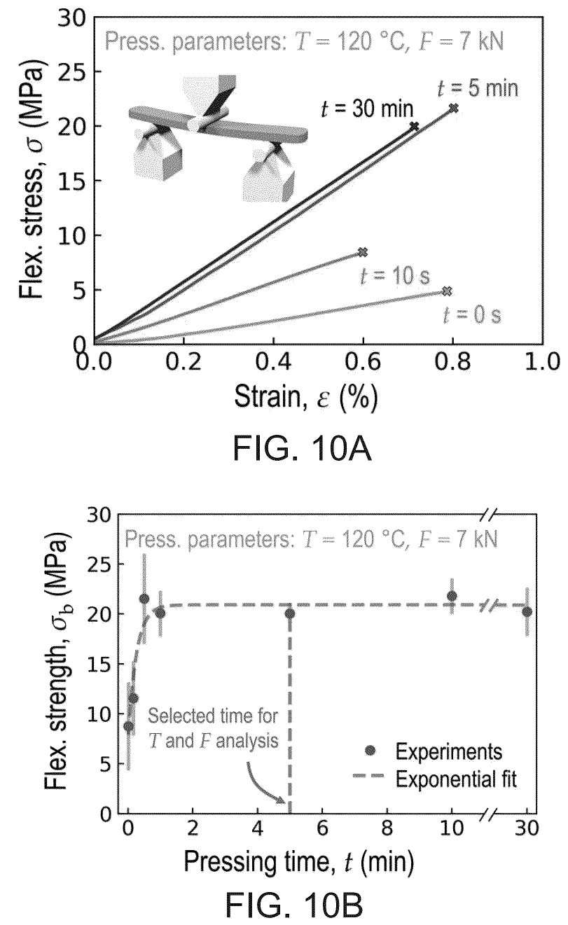

Changes in pre-processing, temperature, time, and pressing force may be altered individually or in combination and may confer different properties on the physical and mechanical properties of the resulting bioplastics. For example, alterations in temperature alter the strength of bioplastics even if the pressure and time are constant as shown for spirulina alone in FIG. 9A. As shown in FIG. 9B, pressing time changes the strength of an example spirulina bioplastic up to an optimal pressing time of 5 minutes. Changes in temperature vary the strength of example spirulina-based bioplastics by as much as 2080% with the weakest bioplastic pressed at 60 and strongest at 140° C. (both pressed at F=7 kN; pressure of 14.9 MPa). The stress/strain and flexural strength profile of the bioplastic also changes in relation to time as shown at FIGS. 10A and 10B.

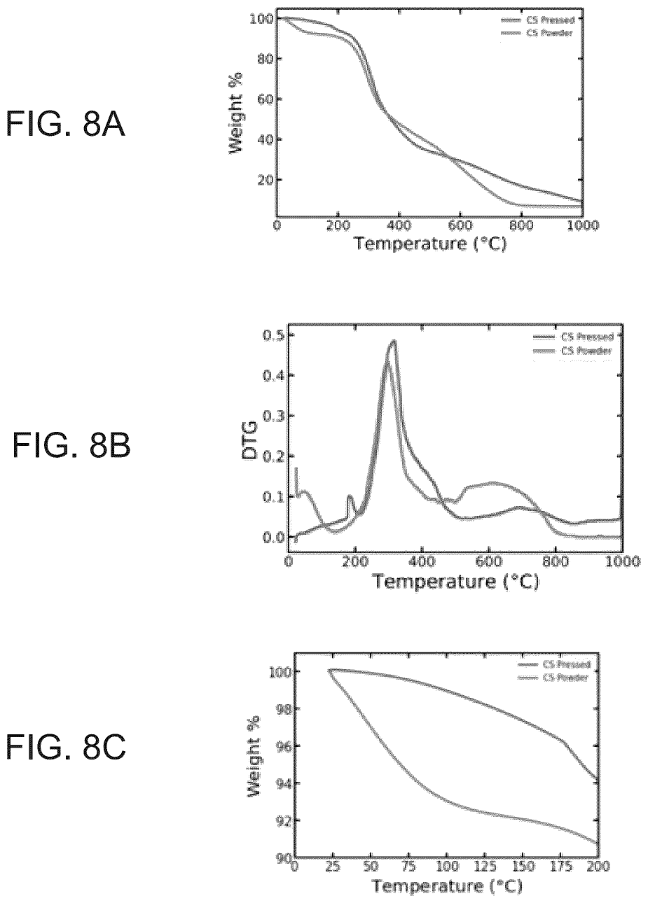

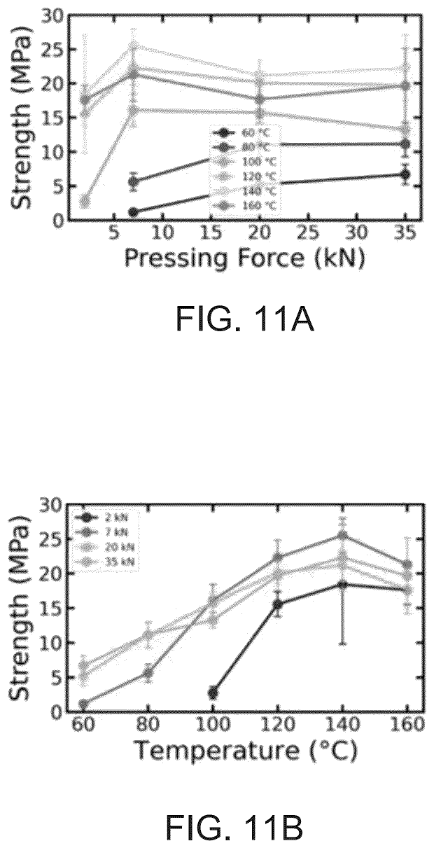

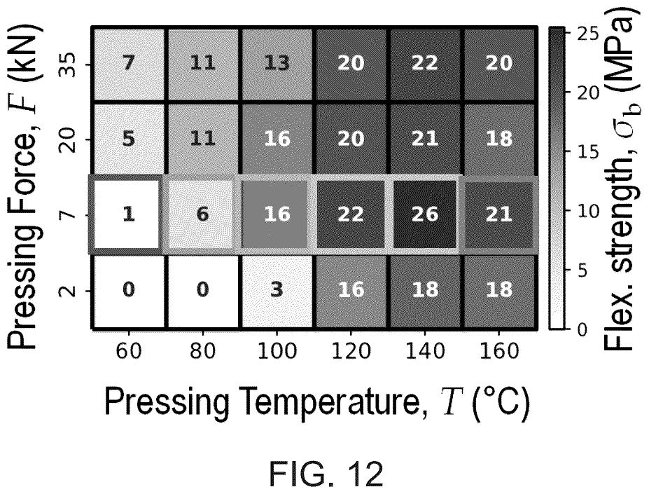

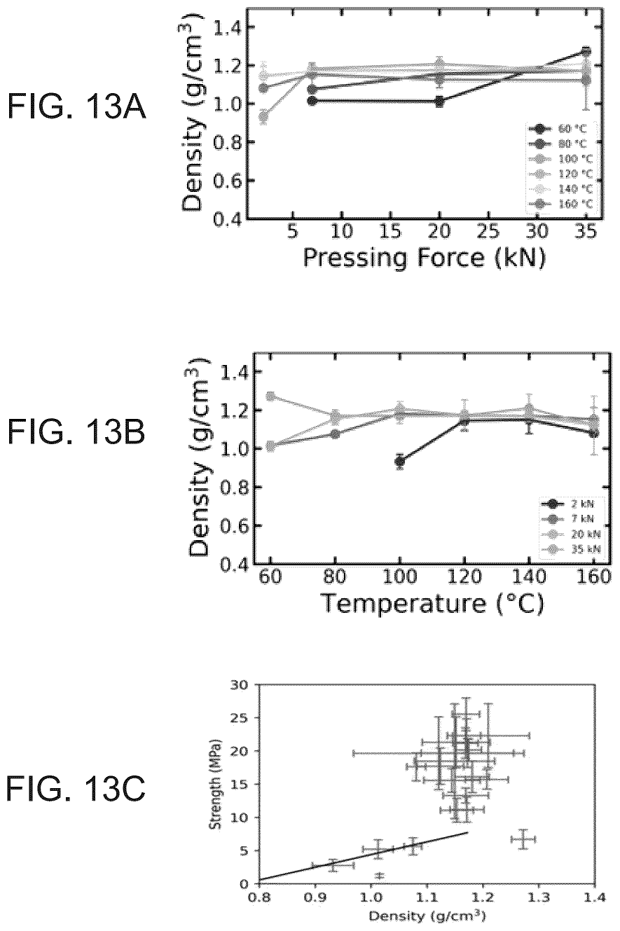

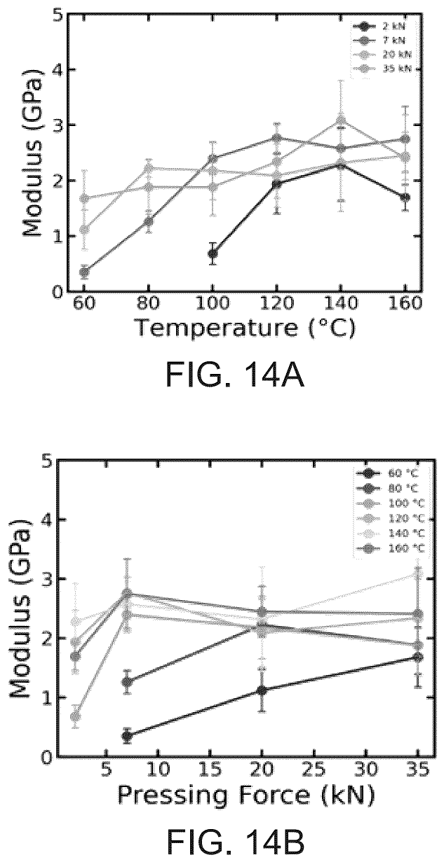

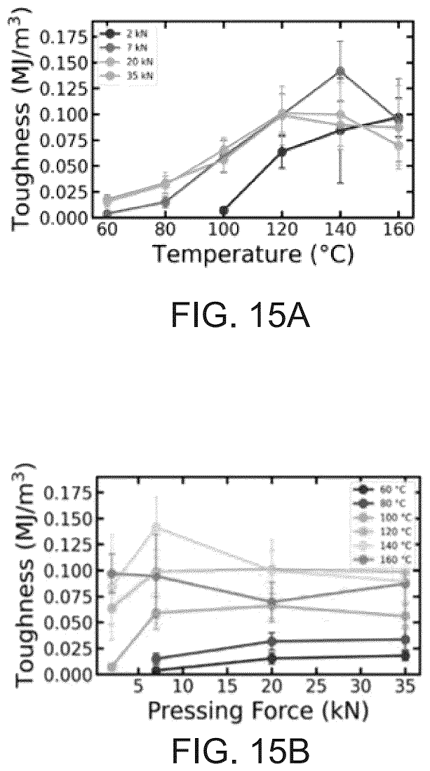

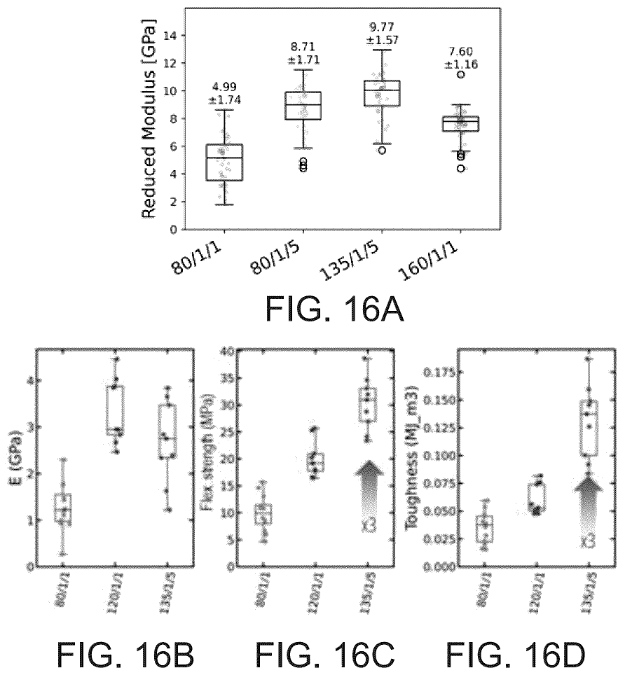

The effect of combinations of changes to temperature, pressure and time can also alter a number of different properties of spirulina-based bioplastics including strength, density, elasticity, and toughness. As shown in FIGS. 11A, 11B, and 13A-C, various combinations of pressure and temperature impact the strength and density of example spirulina bioplastics. The heatmap of FIG. 12 shows varying combinations of temperature/pressure conditions, with a low bending strength of 1.2 MPa at the lower end of the temperature/pressure conditions, as an example specimen remained in a loosely bonded powder form with intact and distinct cells still visible in the SEM, and a high bending strength of 25.5 MPa when pressed at 140° C. and 7 kN. The SEM shows a completely different morphology, with a smooth fracture surface of the strongest spirulina evaluated showing no distinguishable spirulina cells. At the higher end of the pressing conditions, thermal degradation initiation was observed, with a reduction in strength to 17.4 MPa. As shown in FIGS. 8A-8C, degradation appears to start at about 180° C. Manipulation of various combinations of temperature, pressure also altered the elasticity of the resulting bioplastics as shown at FIG. 14A and FIG. 14B and the toughness of the resulting bioplastics as shown at FIGS. 15A and 15B. Combinations of different temperatures/hot press pressures/time changes and their resulting impact are shown in FIGS. 16A-D. Thus, the relative strength of the resulting bioplastic may be adjusted to meet the requirements of the planned end product.

While not wishing to be bound by any particular limitations, it is theorized that specific temperature/pressure/time ratios may unexpectedly change the state of the bioplastics. For example, in some aspects, increasing the temperature of fabrication may enable the transition of a biomatter from a loosely bonded mass of cells to an amorphous uniform matrix. As shown in the SEM photographs in FIGS. 4A-B, in the weakest bioplastics, parts of the cells are still visible and there are voids present in the final material in FIG. 4A. In contrast, in FIG. 4B, the sample appears smoothed out, and there are no individual cells visible. Such changes in stage have not been observed in earlier versions of spirulina based bioplastics.

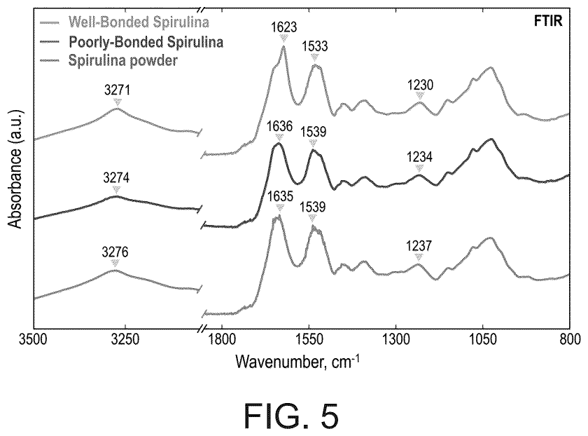

The change in state may result in a smoother surface in the final product as described in Example II, below. Further, variations in pressure resulted in differences in infrared spectroscopy imaging as shown in FIG. 5. While not wishing to be bound by any particular limitations, the imaging suggests that there is an increased amount of β-sheets and changes in hydrogen bonding after thermomechanical processing at higher temperatures. The unexpected transformation from an example of a loosely bonded mass of cells to an amorphous uniform matrix is also evident in the density at various pressing forces and temperatures as shown in FIGS. 13A-C. Further, in various examples of the present disclosure, as shown in the thermogravimetric analysis, spirulina powder loses significantly more mass at the beginning of the temperature increase than well-bonded spirulina.

The unexpected self-bonding of spirulina powder allows for the creation of strong, flexible, backyard compostable bioplastics with mechanical properties ranging from 1.2-25.5 MPa for flexural strength, 0.35-3.1 GPa for flexural modulus for example 1 to 3.5 GPa, 0.63%-1.14% for strain to break, and 0.01-0.14 MJ m⁻³ for work to fracture. Example bioplastics contemplated herein may have one or more mechanical properties in these ranges or subsets thereof. For comparison, PLA has a strength of 21-60 MPa and stiffness of 0.35-3.5 GPa (A. Z. Naser, I. Deiab, B. M. Darras, RSC Adv. 2021, 11, 17151.). TPS has a strength below 6 MPa and stiffness less than 1 GPa (K. M. Dang, R. Yoksan, E. Pollet, L. Avérous, Carbohydr. Polym. 2020, 242, 116392; Y. Zhang, C. Rempel, Q. Liu, Crit. Rev. Food Sci. Nutr. 2014, 54, 1353). Unexpectedly, the spirulina based products described herein have improved mechanical properties in view of previously reported spirulina bioplastics, which were reported to have a strength of 3.0 MPa and stiffness of 249 MPa (Zeller et al., J. Appl. Polym. Sci., 2013, 130, 5).

As shown in FIG. 11A and FIG. 11B, the temperature threshold to achieve a bulk material varies significantly with the choice of applied pressure in the compression molding process. Low pressures may shift the temperature threshold to higher values while higher pressures reduce that temperature threshold. In various examples, the maximum average modulus of 3.1 GPa was achieved at 35 kN and 140° C. In various examples, the minimum modulus was achieved at 7 kN and 60° C.

Along with bioplastics made of biomatter alone, in some implementations, the biomatter may be combined with one or more matrix materials such as proteins (including gluten, lactalbumin, BSA); lignin; cellulose (including bacterial cellulose fibers, nanocellulose, cellulose nanocrystals, cellulose nanofibers, alpha cellulose, carboxymethylcellulose); hemicellulose (including xylan, glucomannan); and other carbohydrates (including starch, isomalt, sucrose). In various examples, fillers such as small (low molecular weight) sugars/carbohydrates (polyols like sorbitol, mannitol, glycerol); Lipids/fatty acids (including stearic acid, oleic acid, linoleic acid, palmitic acid, caprylic acid, lauric acid), nanoclays (montmorillonite, halloysite), nanocellulose, and diatoms. Additional materials that may be combined with the algal materials included viscosity modifiers such as small (low molecular weight) sugars/carbohydrates (polyols like sorbitol, mannitol, glycerol), and lipids/fatty acids (including stearic acid, oleic acid, linoleic acid, palmitic acid, caprylic acid, lauric acid, palm oil) as well as components that enhance electrical conductivity such as graphene, CNTs, carbon fibers, graphite or the magnetic properties of the compositions such as iron oxide particles.

The bioplastics described herein may additionally be combined with commercial polymer such as PLA; PBAT; PHAs including copolymers such as Poly(3-hydroxybutyrate-co-3-hydroxyvalerate; PBS; polyethylene; polypropylene; polystyrene; polycarbonate; and maleic anhydride.

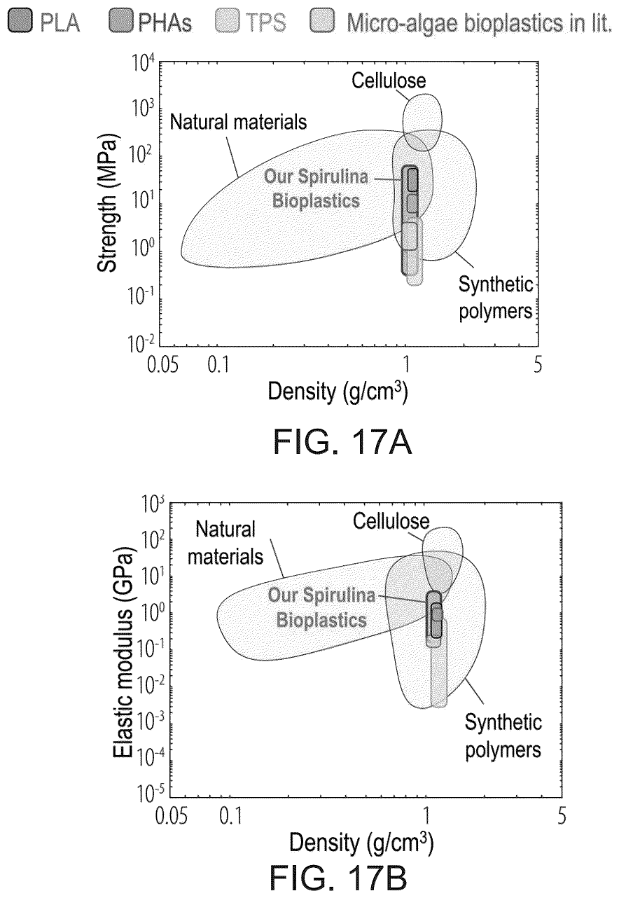

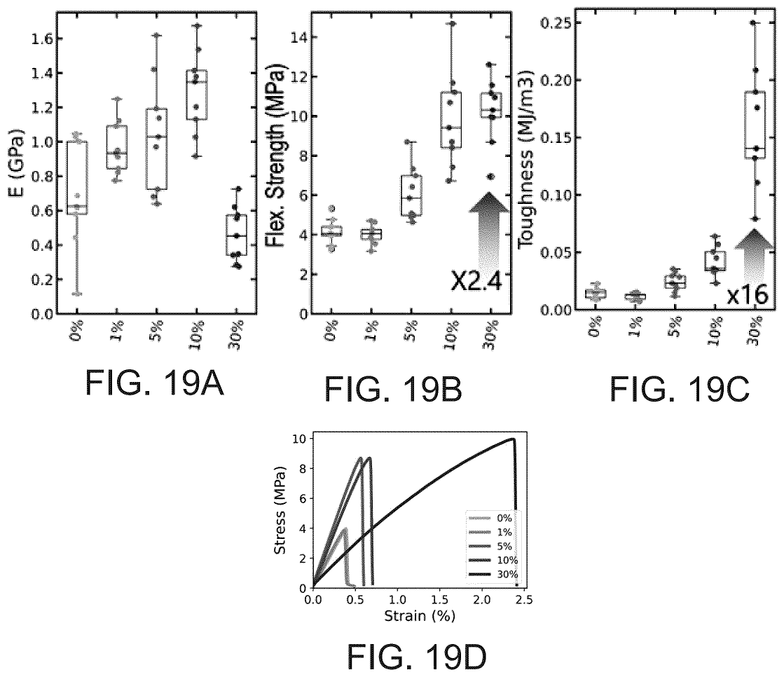

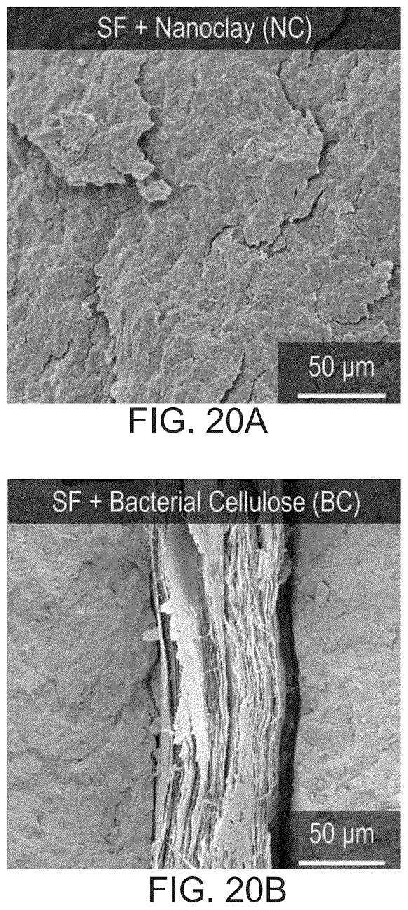

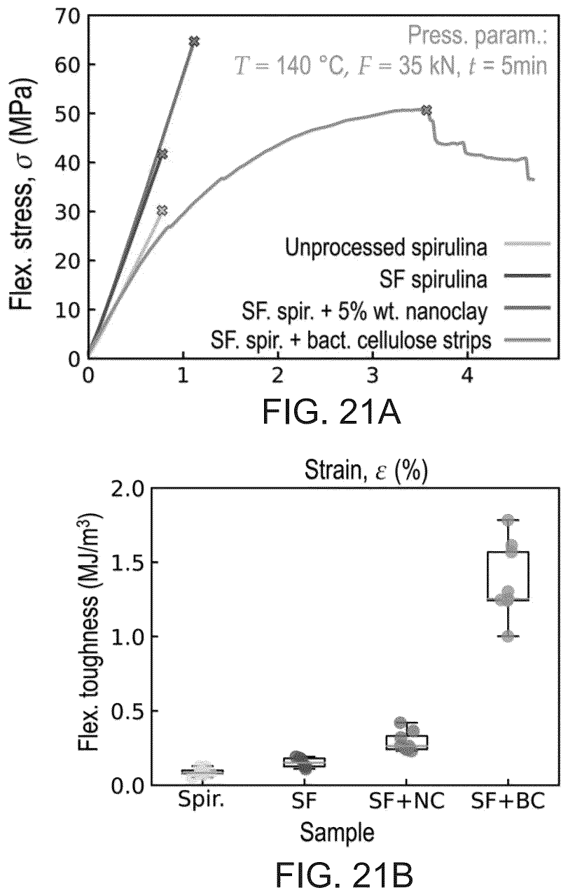

As shown in FIGS. 17A and B, the strength of the spirulina based bioplastics (pure spirulina and spirulina based composites including at least 70% spirulina) has greater elastic modulus than other microalgae bioplastics and particular bioplastics as described herein have greater strength than known microalgae bioplastics. Such combinations may confer different mechanical and physical characteristics on the resulting bioplastics whether made of biomatter alone or biomatter composites. For example, as shown in FIGS. 4A and 4B, production of bioplastics as described herein creates a more homogenous plastic. As shown in FIGS. 18A-C, combinations of spirulina and sorbitol also alter the morphology of the resulting bioplastics. The combination of spirulina and sorbitol additionally alters flexural stiffness, strength, and toughness in samples pressed at 80° C./2 kN/1 min as shown in FIGS. 19A-C. Additions of other additives also impart different physical and mechanical properties as shown in FIGS. 20A-21B.

To fabricate example biomatter plastics described herein, the components for the bioplastics may be combined using methods known to those of ordinary skill in the art. In some aspects, the components may be combined using dry powder mixing, in which the components are combined using any mixer generally known to one of ordinary skill in the art, or wet solution blending, in which water is added to the dry components and probe sonication or planetary mixing is used to homogenize the mixture. In some aspects, one or more of the components are pre-treated, for example using sonication and/or freeze drying.

The combined components are then subjected to a thermoforming step using compression molding, a heated extruder, a hot-press, injection molding, or any device that can apply pressure and heat to the mixtures. In some aspects, the processing temperatures may be between 60-200° C. The pressing forces between 1-150 N/mm². The time in which the pressure and temperature is applied may be 0.5-30 minutes. For example, the time may be 5 minutes, the temperature between 120 and 160° C. and the pressing force 7 kN. For some bioplastics with additives, the operating conditions for the extruder range from: 65 to 140° C. and 10-50 rpm or fractions thereof. Bioplastics with additives can also be formed a hot-press operating between 60 and 175° C. and 1-50 kN (corresponding to a force per unit area of the sample of around 2-100 N/mm²). Further examples of combinations of bioplastics may be found at least in Examples III to VI as well as throughout the application. Exemplary embodiments of bioplastics and the manufacturing methods are shown in Table 1.

TABLE 1
Tested Materials and Manufacturing Methods/Conditions for Bioplastics

| | | | | | Manufacturing |
|---|---|---|---|---|---|
| | | | | | Pressing |
| | | | | | Forces per |
| | | | | | unit area of |
| | | | | Manufacturing | pressed |
| | | | Manufacturing | Temperatures | sample |
| Material 1 | Material 2 | Material 3 | Method | (° C.) | (N/mm²) |
| Spirulina | | | Compression | 60-160 | 1-100 |
| | | | molding | | |
| Spirulina | Sorbitol | | Extrusion, | ≤90 | 0 |
| | | | compression | | |
| | | | molding | | |
| Spirulina | Glucomannan | | Solution | 60-170 | 1-100 |
| | | | Blending, | | |
| | | | Lyophilization, | | |
| | | | Hot pressing | | |
| Chlorella | | | Compression | 60-160 | 1-100 |
| vulgaris | | | molding | | |
| Saccharina | | | Compression | 60-160 | 1-100 |
| latissima | | | molding | | |
| (sugar kelp) | | | | | |
| Ulva | | | Compression | 60-160 | 1-100 |
| | | | molding | | |
| Alpha | | | Compression | 20-75 | 1-150 |
| cellulose | | | molding | | |
| Powdered | | | Compression | 95-175 | 1-150 |
| wood | | | molding | | |
| (Douglas fir) | | | | | |
| Açai | | | Compression | 60 | 1-100 |
| | | | molding | | |
| Coffee | | | Compression | 150 | 1-100 |
| beans | | | molding | | |
| Dragon | | | Compression | 20-75 | 0-150 |
| fruit | | | molding | | |
| Dragon | Alpha | | Compression | 20-50 | 0-100 |
| fruit | cellulose | | molding | | |
| Matcha | | | Compression | 60-160 | 1-100 |
| | | | molding | | |
| Matcha | Sorbitol | | Compression | ≤90 | 0-1 |
| | | | molding | | |
| PLA | Spirulina | | Extrusion, | 160-190 | |
| | or | | compression | | |
| | Chlorella | | molding, | | |
| | | | injection | | |
| | | | molding, 3D | | |
| | | | printing | | |
| PBAT | Spirulina | | Extrusion, | 110-130 | |
| | or | | compression | | |
| | Chlorella | | molding, | | |
| | | | injection | | |
| | | | molding | | |
| PEO | Spirulina | | Extrusion, | 60-80 | |
| | or | | compression | | |
| | Chlorella | | molding, | | |
| | | | injection | | |
| | | | molding | | |
| PEO | Spirulina | Sorbitol | Solution | 60-80 | |
| | | | Blending, | | |
| | | | Lyophilization, | | |
| | | | Extrusion | | |
| PCL | Spirulina | | Extrusion, | 50-70 | |
| | or | | compression | | |
| | Chlorella | | molding, | | |
| | | | injection | | |
| | | | molding | | |
| PHBV | Spirulina | | Extrusion, | 150-180 | |
| | or | | compression | | |
| | Chlorella | | molding, | | |
| | | | injection | | |
| | | | molding | | |
| PHBV | Spirulina | | Extrusion, | 150-180 | |
| | or | | compression | | |
| | Chlorella | | molding, | | |
| | | | injection | | |
| | | | molding | | |
| PE | Spirulina | | Extrusion, | 110-140 | |
| | or | | compression | | |
| | Chlorella | | molding, | | |
| | | | injection | | |
| | | | molding | | |
| PP | Spirulina | | Extrusion, | 150-170 | |
| | or | | compression | | |
| | Chlorella | | molding, | | |
| | | | injection | | |
| | | | molding | | |
| PLA | PBAT | Spirulina | Extrusion, | 160-190 | |
| | | or | compression | | |
| | | Chlorella | molding, 3D | | |
| | | | printing | | |
| PLA | PEO | Spirulina | Extrusion, | 160-190 | |
| | | or | compression | | |
| | | Chlorella | molding, 3D | | |
| | | | printing | | |

SEM imaging provides some insight into the unexpected self-bonding along with the change in mechanical properties of spirulina bioplastics and composite spirulina bioplastics. While the self-bonding of spirulina appears to come from molecules within the spirulina cells, the sorbitol-plasticization of spirulina appears to come from the melting of sorbitol. Sorbitol has a melting temperature of around 90° C. When the sorbitol is heated and pressed along with the spirulina, the sorbitol melts and in some aspects the sorbitol may diffuse in the spirulina matrix and react with the spirulina polymers. The amount of sorbitol in the spirulina composite created according to the methods described herein provides different materials with different properties than the self-bonded spirulina, and may make stronger and tougher samples if combined with the method of self-bonding used for the pure spirulina samples as described herein. Combinations of spirulina with additional compositions such as nanoclay and cellulose also alters the strength and toughness of exemplary resulting bioplastics as shown in FIGS. 21A and 21B.

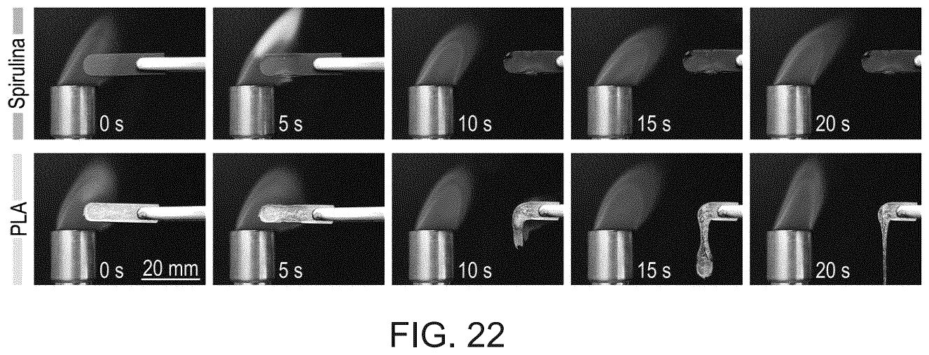

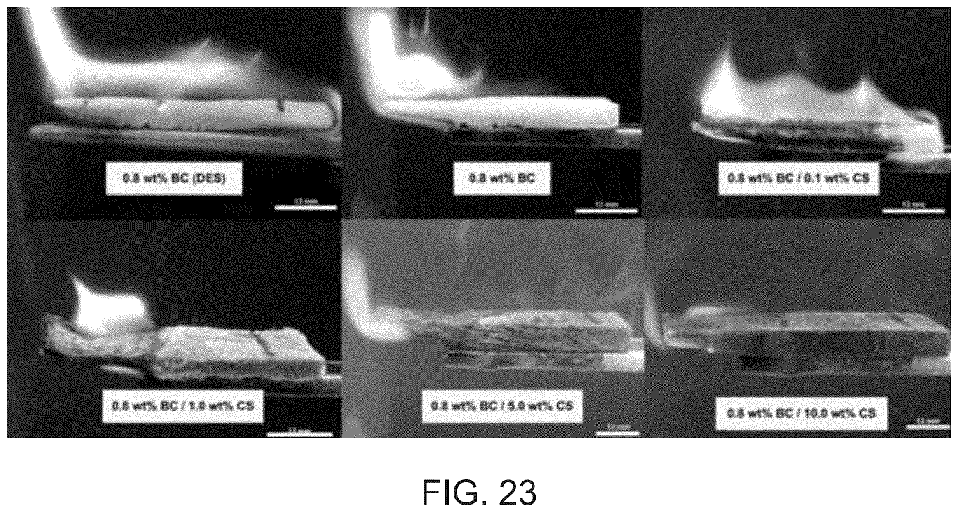

The combination of spirulina with other matrices and plasticizers may also alter the flammability of such bioplastics. As shown in FIG. 17A and FIG. 17B, example spirulina bioplastics have a different profile than other industrially compostable bioplastics, such as PLA. As shown in FIG. 22, after exposure to an open flame for 10s, the spirulina bioplastic sample self-extinguished within less than 1s and produced a char while PLA combusted and melted leaving no solid residue. Cellulose has a burn rate of about 20-25 mm/s for samples 75×25×6.5 mm. Adding spirulina biomass can reduce this down to 0.6 mm/s or lower, depending on how much is included. Even small amounts of spirulina (CS) can slow down the burn rate and produces char in composite bioplastics such as bacterial cellulose (BC) as shown in FIG. 23. In some aspects, spirulina may be a flame retardant in compositions including cellulose as well as additional polymer matrices such as poly lactic acid (PLA), low density polyethylene (LDPE), high density polyethylene (HDPE), and (polybutylene adipate terephthalate) PBAT.

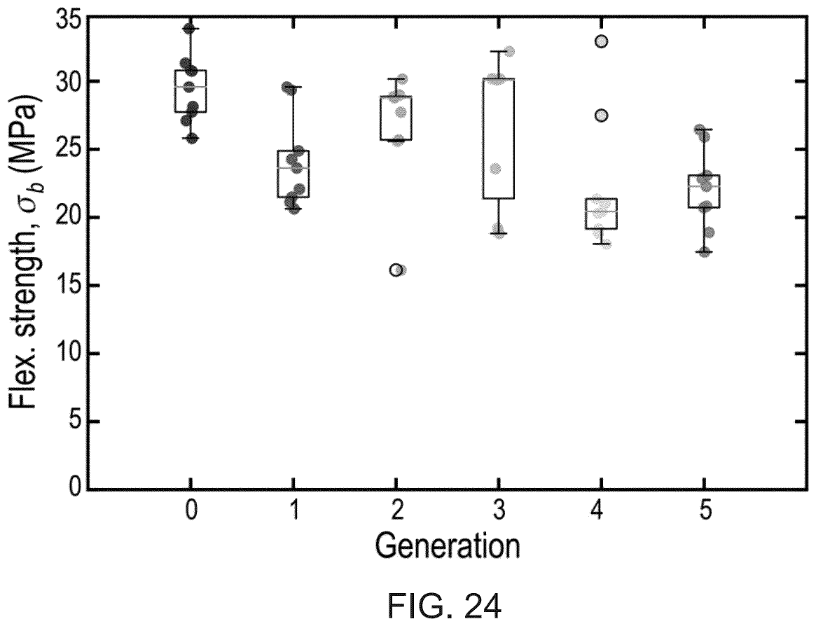

Various bioplastics described herein may also be reusable. In some aspects, the bioplastics may be ground at the end of their initial life cycle and re-formed as described above. As shown at FIG. 24, the re-formed bioplastics have similar strengths to new bioplastics for several generations and are therefore reusable. Such reusability may be enhanced through the use of combinations of new and pre-used ground compositions at percentages ranging from 0-99% wt.

Various bioplastics described herein may also be backyard compostable (Law, K. L., Narayan, R. Reducing environmental plastic pollution by designing polymer materials for managed end-of-life. Nat Rev Mater 7, 104-116 (2022). doi.org/10.10381s41578-021-00382-0). As used herein, backyard compostable means biodegradable at rates similar to food waste of the same surface area. Biodegradable plastics are plastics that are completely metabolized by microorganisms in an end-of-life (disposal) system, as measured by the microbial conversion of plastic carbon to CO₂ (or CO₂+CH₄) as a function of time.

Decelerating degradation kinetics may be calculated using Equation 1 as follows:

dα/dt=k(1−α)ⁿ (1)

where α=Δm/m0 corresponds to the degree of conversion with Δm the mass variation and m0 the initial mass of the buried sample,

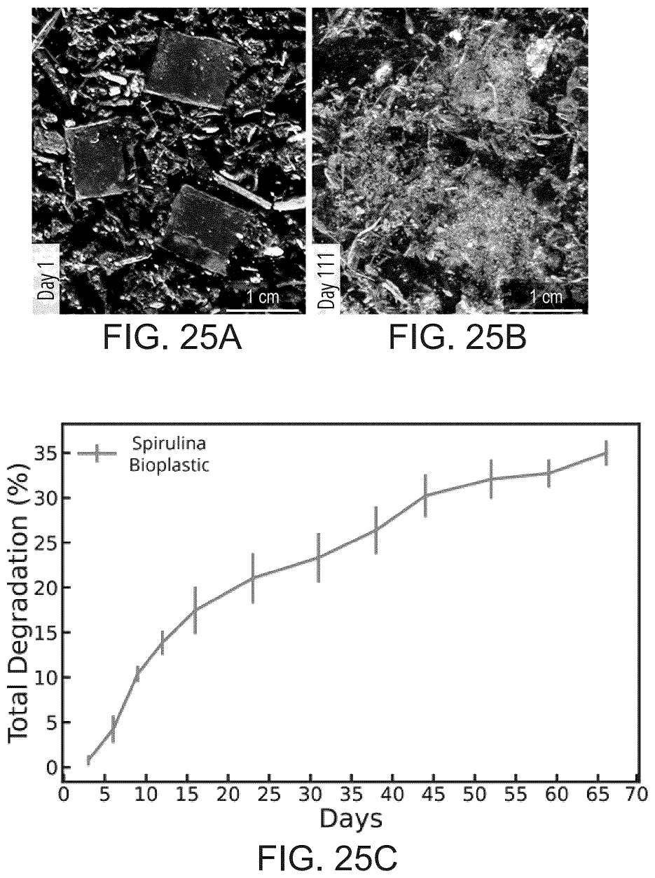

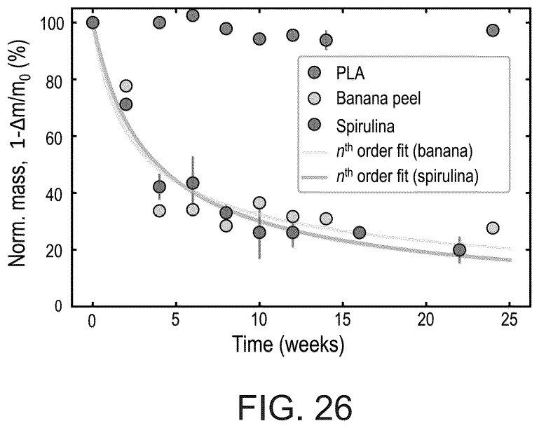

As shown in FIG. 25A and FIG. 25B, there was significant decomposition by day 70 and advanced decomposition of spirulina at day 111. Further, as shown in FIG. 26, spirulina decayed at the same rate as a banana peel. It is noted that the PLA sample is hovering at over 99% of its initial weight, indicating almost no mass loss for what is one of the most commercially available compostable plastic. Meanwhile, the spirulina bioplastic follows the degradation of another fully natural material, a banana peel. At six weeks, the spirulina bioplastic and banana peel had lost approximately 60% of their mass, showing that the spirulina bioplastics have a desirable combination of mechanical properties and degradability. In some aspects, various bioplastics described herein may lose at least 15% of the initial mass after 6 weeks. In other aspects, they may lose 60% of their mass. In particular embodiments, the bioplastics described herein may have degradation rates comparable to other household backyard compostable items such as fruits and vegetables.

In order that various implementations described herein may be more fully understood, the following examples are set forth. Those of skill in the art should, in light of the present disclosure, appreciate that many changes can be made in the specific embodiments which are disclosed and still obtain a like or similar result without departing from the spirit and scope of the disclosure. Further, it should be understood that these examples are for illustrative purposes only and are not to be construed as limiting the scope of this disclosure in any manner.

### EXPERIMENTAL EXAMPLE

### Example I

### Fabrication of Spirulina Bioplastics

Spirulina algae cells were procured from Nuts.com as Organic Spirulina. An aqueous suspension of the as-received spirulina cells in a 1:10 w/w concentration was sonicated for 20 min using Fisher Scientific Model 505 probe sonicator, on an ice bath. As shown at FIG. 3A, sonication of spirulina reduced the particle size from 28.3±16.6 to 5.5±3.5 μm. After sonication, the dissociated biomatter suspension was freeze-dried using a Freezone lyophilizer from Labcono Corp.

The powder was then subjected to a compression molding process on a TMAX-SYP-600 hot press from TMAXCN, using custom-made stainless-steel molds. These molds were loaded with 1 g of spirulina per sample to produce beams with lengths and widths of approximately 60 and 8 mm, respectively. Samples were curved at the ends with radii of approximately 3.5 mm.

After production, each sample was labeled and placed in a desiccation chamber for 24 hours. Once a specimen had reached at least 24 hours of desiccation, their thicknesses, widths, and masses were measured and the samples were subjected to additional analysis via imaging and mechanical testing.

### Example II

### Mechanical Testing of Spirulina Bioplastic

The spirulina powder as prepared in Example I was subjected to a compression molding process on a TMAX-SYP-600 hot press from TMAXCN, using custom-made stainless-steel molds. The temperature, pressure, and time of pressing was varied among different samples. Temperatures ranging from 60 to 160° C. were increased 20° C. in a step-wise fashion while pressing forces of 2, 7, 20, and 35 kN were used. The duration of the hot-pressing process was measured starting when pressing force was achieved. The samples that were tested in compression had a cube geometry (length of 25.4 mm for each side) and were prepared using an aluminum square tube with an inner edge length of 1 inch. The hot press conditions for those samples were set to 140° C., 7 kN, and 10 min, although extra time was allowed for packing the powder down in steps to avoid exceeding the stroke of the hot press piston.

### Time

One set of samples was subjected to pressing time, t, between 0 and 1800 s (30 min) under fixed temperature and pressing force conditions of T=120° C. and F=7 kN and the samples were tested for stress/strain as a function of time as shown in FIG. 10A. The flexural strength (ab) is reported as function of pressing time as shown in FIG. 10B, along with an exponential fit (dotted green line) of the form shown in Equation 2:

σ*(t)=σ0+(σp−σ0)(1−exp−t/τ) (2)

According to this fit, the strength increases from σt=0=8.8 MPa up to a plateau value of approximately σp=20.9 MPa with a characteristic time constant τ=15.4 s. At pressing times below 60 s (≈4τ), the strength is significantly lower than the plateau strength and the data exhibit higher standard deviations than at longer pressing times. Below this threshold, the pressing time is not sufficient to facilitate the formation of a bonded uniform spirulina matrix.

### Temperature

A second set of samples used a fixed pressing time of the conservative value of 300 s (20τ, dotted line in FIG. 10B). At that fixed pressing time, the temperature was varied from 60 to 160° C. and the pressing force from 2 to 35 kN (corresponding to applied pressures in the range from 4.3 to 74.5 MPa).

As shown in the heat-map of FIG. 12, a region of maximal strength is observed for temperatures between 120 and 160° C. and a pressing force of 7 kN. As shown in FIG. 10A, there was a progressive strength increase with increasing temperature up to a maximum value at 140° C., beyond which strength decreases. This drop in strength at high temperatures (160° C.), is seen for all pressing forces at or above 7 kN. While not wishing to be bound, it is theorized that the drop in strength at high temperatures is due to the initiation of thermal degradation reactions in spirulina. The bending modulus and toughness follow similar trends as shown in FIG. 14A, FIG. 14B, FIG. 15A, and FIG. 15B. Overall, the mechanical tests show a strong dependency of the flexural strength of the produced bioplastics on the pressing temperature, with variations between the weakest bioplastic pressed at 60 and strongest at 140° C. (both pressed at F=7 kN; pressure of 14.9 MPa) as high as 2080%.

### Pressing Force

Compressive strength was measured at 76.1±3.9 MPa in the axial direction (with respect to the hot pressing direction), and 70.2±2.9 MPa in the transverse direction (7.7% difference). While not wishing to be bound to any particular limitations, this small but statistically significant difference (p-value 0.04) is attributed to the fact that during the fabrication process, the compaction and binding of the bioplastics are naturally enhanced along the hot-pressing direction before a continuous matrix is formed. Interestingly, compression tests reveal a nearly isotropic behavior.

As shown in FIG. 11A, the 7 kN pressing condition produced higher strengths than the higher pressing force conditions. This may be explained by the observation that higher pressing conditions caused so much plasticity in the spirulina at higher temperatures that the material flowed out of the gaps in the mold, leading to thinner, less easily manufacturable parts.

### Combinations of Time/Pressure/Temperature

At the lowest (in this example) pressing force of 2 kN there was a significant jump in flexural strength as the temperature increases from 100 to 120° C. (from 2.75±0.90 to 15.54±1.78 MPa), at which point a plateau is reached in strength (FIG. 11A). At a pressing force of 7 kN, the strength increases from 1.17±0.27 MPa to 25.52±2.47 MPa. The strength then drops to 21.28±3.85 MPa when pressed at 160° C., which may indicate the onset of degradation, although the overlap in error bars between those two temperatures makes that claim unsubstantiated. At 20 and 35 kN pressing forces, the low temperature strengths were higher than at the lower pressing forces (5.18±1.43 MPa and 6.68±1.46 MPa, respectively), but they still see significant increases at 120° C., at which point the strengths plateau at 20.10±1.63 and 19.67±2.17 MPa, respectively. FIG. 11B shows that a pressing temperature of 140° C. consistently produces higher average flexural strengths, while 160° C. generally produces lower average strengths than at 120 and 140° C., again most likely because of the onset of degradation. The maximum strength of 25.5 MPa is reached at pressing conditions of 140° C. and 7 kN. While the degradation temperature can explain the downward trend of the data after 140° C., it is also noticed that the 7 kN pressing condition produced higher strengths than the higher pressing force conditions. This may be explained by the observation that higher pressing conditions caused so much plasticity in the spirulina at higher temperatures that the material flowed out of the gaps in the mold, leading to thinner, less easily manufacturable parts. The demolding process for these specimens was difficult as the specimens ended up being rather fragile. A pressing force of 7 kN, for instance, may be used to generate a material with a relatively high strength value without disrupting the manufacturing process.

Similarly, there was a substantial increase in elastic modulus (from 0.68±0.19 to 2.04±0.47 GPa) at the lowest (tested) pressure force of 2 kN as the temperature increased from 100 to 120° C., which was maintained for the 140° C. and was slightly reduced (to 1.69±0.23 GPa) at 160° C. as shown in FIG. 14B.

The AGS-X (10 kN) test frame, made by Shimadzu Scientific Instruments in Columbia, MD, USA, was used in a three-point bending configuration to test elastic modulus. All samples were tested at a 0.5% strain rate. The stress on a sample in three-point bending is calculated using Equation 3:

$${σ}_{f} = \frac{3 F L}{2 {bd}^{2}} , \qquad ( 3 )$$

where σ_{f} is the flexural stress at the outer surface at the midspan of the beam, F is the load at a point on the load-displacement curve, L is the support span of the test setup, b is the width of the specimen, and d is the depth of the specimen. The support span for these tests were either 40 mm or 20 mm. Full specimens were tested at the 40 mm span length, with the sample breaking in half. Each half was then tested on the 20 mm support span. There was no significant difference observed in the mechanical properties between testing the full specimens and the half specimens, so the procedure was deemed adequate. Three specimens were produced for each trial, giving nine samples total for each trial, when including the number of half-specimens tested on the 20 mm span. The bending modulus follows the trend for strength as shown in FIG. 14A.

The significant increase-plateau-decrease trend of the elastic modulus was only observed to that extent at the minimum pressure conditions (2 kN) indicating that at this low pressure condition a temperature of 120-140° C. is required for the samples to reach the maximum elastic modulus. At lower temperatures the loose packing results in non-well-bonded bioplastics as shown in FIG. 4A, while at maximum temperature thermal degradation initiation may be negatively affecting the sample performance. At a higher pressing load of 7 kN, the same substantial increase in modulus (from 0.35±0.12 to 2.39±0.29 GPa) with temperature increasing from 60 to 100° C. appears as shown in FIG. 14A and FIG. 14B. Then the modulus plateaus and does not decrease at the maximum tested temperature of 160° C. Similar modulus fluctuations exist but are smaller at a higher pressing load of 20 kN. A small increase (from 1.18±0.31 to 2.22±0.16 GPa) is observed when temperature increases from 60 to 80° C. and a plateau is reached above that threshold. In the maximum (tested) pressure loads of 35 kN, the plateau is obtained even at 60° C. but the larger deviations for each sample indicate that the degree of uniformity in the samples is more variable than in any other pressing condition. Thus, the temperature threshold to achieve a bulk material varies significantly with the choice of applied pressure in the compression molding process. It is possible that low pressures shift the required temperature threshold to higher values while higher pressures reduce that temperature threshold. Yet the maximum tested pressure clearly is preventing homogenous sample formation as the error bars are significantly higher in these conditions. The maximum average modulus of 3.1 GPa was achieved at 35 kN and 140° C. The minimum modulus was achieved at 7 kN and 60° C.

Nanoindentation was used to calculate a reduced modulus to characterize the stiffness in accordance with Equation 4.

Eᵣ=1/β√π/2S/√(A_p(h_c)) (4)

Eᵣ is the reduced Young's modulus, β is a geometrical constant for the specific type of indenter, S is the stiffness as measured by the slope of the load-displacement curve at the point of unloading, and Ap(hc) is a fitting polynomial specific to the type of indenter being used. For these tests, a Berkovich tip was used. The reduced modulus was used in this study to confirm the trends of flexural modulus produced by the three-point bend testing. The nanoindentation machine used for this experiment was an FT-MTA03 produced my Femto Tools.

FIG. 16A shows the reduced modulus measured for each sample, with a “weak” sample at 80/1/1, two relatively strong samples in the middle, and a sample in the degradation temperature region at 160/1/1. The nanoindentation data corroborates the trend that is seen in FIG. 14A and FIG. 14B, with stiffness increasing with the intensity of the pressing conditions and dropping once the material starts to degrade.

Density was plotted versus temperature and pressing force to examine any relationships between the three variables, as shown in FIG. 13A-C. In some aspects the density may range from 0.5 to 1.5 g/cm³, 0.9 to 1.5 g/cm³. In the Density vs Temperature plot of FIG. 13B, it is generally observed that as temperature increases, the density of specimens approaches approximately 1.2 g/cm³. At lower temperatures, the scatter in densities can be explained by the lack of plasticization in the specimens. The materials are a packed powder with loose bonding rather than a plastic piece, so the force at which the samples are pressed has a higher impact on the density. In the Density vs Pressing Force of FIG. 13A, a similar trend is observed. Density generally does not change significantly as pressing force is increased except for at the lowest of temperatures, while the densities see greater change from temperature line to temperature line.

The last part of the density analysis was analyzing the density vs the strength of the materials. FIG. 13C shows a plot of error bars in both the strength and the density axes, with the center of the error bars being the average value coordinate. This plot shows the large amount of grouping around the 1.1 to 1.2 g/cm³ density values, with strengths varying significantly in that range. Meanwhile, some samples are significantly less dense, with one outlier being more dense but also less strong. All this data indicates that it is not merely powder packing that is affecting the strength of these materials, there is an actual change going on that leads to a plasticized part that can be tuned higher or lower in strength and toughness based on hot pressing parameters.

The toughness of the specimens was similarly plotted against temperature and pressure in FIG. 15A and FIG. 15B. The toughness plots show almost the same trends as the strength plots. At the lowest pressing force of 2 kN, there is again a significant jump in toughness from 100 to 120° C., from 0.01±0.00 to 0.06±0.02 MJ/m³, and it continues to increase up to 0.10±0.02 MJ/m³. At 7 kN, the toughness at 60° C. is essentially zero, while it climbs up to 0.14±0.03 MJ/m³ at 140° C. It then sharply decreases to 0.09±0.04 MJ/m³ at 160° C. At 20 kN, the toughness increases from 0.02±0.01 MJ/m³ at 60° C. to 0.10±0.02 MJ/m³ at 120° C., and decreases to 0.07±0.02 MJ/m³ at 160° C. At 35 kN, the pressing force increases from 0.02±0.00 MJ/m³ at 60° C. to 0.10±0.03 MJ/m³ at 120° C., at which point it reaches a plateau in toughness. The similar trends shown in the strength and toughness plots indicate that, on average, the shapes of the stress strain curves are not very different from each other. The elongation to break was not significantly different across the hot-pressing conditions. The stress strain curves indicate purely brittle failure, although there is ambiguity for the 60° C. samples, which again were mostly packed powder rather than a plastic material.

### Bonding

As shown in the SEM images of FIGS. 4A and 4B, there are significant morphological differences between the weakest and strongest spirulina bioplastic samples (for scanning electron microscopy (SEM), samples were sputter coated with approximately 4 nm of platinum on an EM ACE600, produced by Leica Microsystems and imaged using an Apreo VP, made by ThermoFisher Scientific). The well-bonded sample has a smoother surface with a root mean square height Sq=430 nm, while for the poorly bonded sample, Sq=3.3 μm. As expected, the well-bonded bioplastic resulted in a smoother surface (Sq=3.214 μm) than the weakly bonded samples (Sq=8.978 μm). The mean square height of the weakly-bonded fracture surface is on the order of the spirulina cell dimensions, revealing once more that this sample corresponds to a compacted powder, whereas the well-bonded conditions enable the cells to fuse together.

As shown in FIG. 5, the infrared spectra reveal significant differences between the spirulina powder and the bioplastic pressed at 140° C. Thermomechanical processing at those conditions causes the Amide I, II, and III protein bands of spirulina to shift toward, and increase intensity at, lower wavenumbers. Most notably, the intensity of the Amide I band (1600-1700 cm-1) of pressed spirulina increases significantly at 1623 cm⁻¹. The distinctive double peak formed in the strongest sample contrasts the broad Amide I band in spirulina powder centered at 1635 cm⁻¹. The Amide II and III bands also shift from 1539 to 1533 cm⁻¹ and 1237 to 1230 cm⁻¹, respectively. Together, these transitions indicate the formation of β-sheet conformations in spirulina proteins during pressing (D. M. Byler, H. Susi, Biopolymers 1986, 25, 469; S. Cai, B. R. Singh, Bioph. Chem. 1999, 80, 7; G. Anderle, R. Mendelsohn, Bioph. J. 1987, 52, 69). These shifts observed in the Amide bands of spirulina pressed at 140° C. are not observed after pressing at 60° C. While there is a lesser shift in the Amide III band (from 1237 to 1234 cm⁻¹), the shapes and locations of the Amide I and II bands remain unchanged after hot-pressing using more mild conditions. This suggests that the protein transformation experienced during processing at 140° C. did not occur for the example pressing at 60° C. β-sheet conformations are associated with higher strength and stiffness in proteins than α-helices (S. Keten, Z. Xu, B. Ihle, M. J. Buehler, Nat. Mater. 2010, 9, 359; S. Xiao, S. Xiao, F. Grater, Phys. Chem. Chem. Phys. 2013, 15, 8765). Therefore, the IR observations of an increased amount of β-sheets in the protein-rich spirulina matrix upon thermomechanical processing at a higher temperature (140° C.) support the improved mechanical properties compared to the sample pressed at 60° C. Additionally, the IR spectra reveal a redshift in the O—H band of spirulina (3276 cm⁻¹) after pressing at both 60° C. (3274 cm⁻¹)

and 140° C. (3271 cm⁻¹). Shifts in the O—H peak indicate changes in hydrogen bonding.[43] The slight shift for the 60° C. pressed spirulina, for which significant protein conformational transformation does not occur, may indicate an increase in intermolecular hydrogen bonding that is unrelated to the formation of beta sheets. Therefore, this result suggests that the samples formed at the low-temperature condition are held together via intermolecular hydrogen bonding between the different biopolymers present in the spirulina cell walls and protoplasm, which are typically rich in surface hydroxyl groups (T. Lafarga, J. M. Fernández-Sevilla, C. González-Löpez, F. G. Acién-Fernández, Food Res. Int. 2020, 137, 109356; D. G. Bortolini, G. M. Maciel, I. d. A. A. Fernandes, A. C. Pedro, F. T. V. Rubio, I. G. Brancod, C. W. I. Haminiuk, Food Chem. 2022, 5, 100134). Other types of intermolecular interactions such as biopolymer chain entanglement and Van der Waals interactions may also contribute to the bonding of the samples pressed at lower temperatures. The more significant redshift of the O—H bond in the absorption spectrum of the sample pressed at 140° C. indicates more intermolecular hydrogen bonding in that sample. In this case, increased intermolecular hydrogen bonding can be attributed to both enhanced hydrogen bonding between biopolymers in the spirulina and the transition from α-helices (intramolecular connections) to β-sheets (intermolecular connections).

The samples were additionally examined using Fourier Transform Infrared (IR) spectroscopy and X-ray photoelectron spectroscopy (XPS). Fourier transform infrared spectroscopy (FTIR) was performed using a Thermo Scientific Nicolet iS10 FTIR in ATR mode. Spectra were obtained with a resolution of 2 cm⁻¹ and 128 scans. Scans were performed between 400 and 4000 cm⁻¹. Spectra were vector normalized and distributed vertically for ease of comparison. Peak identification was performed using the scipy.signal.find_peaks function in Python. All XPS spectra were taken on a Kratos Axis-Ultra DLD spectrometer. This instrument has a monochromatized Al Kα X-ray and a low energy electron flood gun for charge neutralization. X-ray spot size for these acquisitions was on the order of 700×300 μm. Pressure in the analytical chamber during spectral acquisition was less than 5×10-9 Torr. Pass energy for survey and detailed spectra (composition) was 80 eV. Pass energy for the high resolution spectra was 20 eV. The take-off angle (the angle between the sample normal and the input axis of the energy analyzer) was 0° (0 degree take-off angle 100 Å sampling depth). CasaXPS was used to peak fit the high-resolution spectra. For the high-resolution spectra, a Shirley background was used and all binding energies were referenced to the C 1s C—C bonds at 285.0 eV.

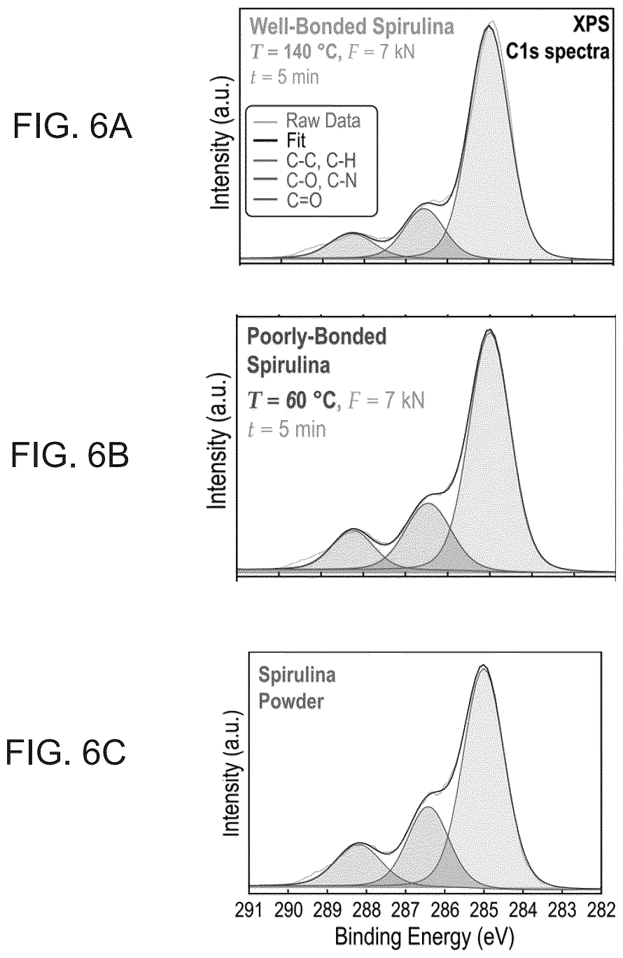

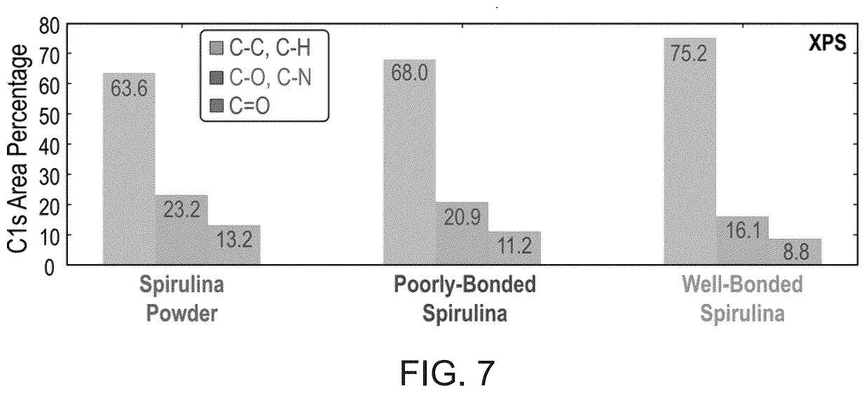

The deconvolution of the collected XPS spectra as shown at FIG. 7 reveals further changes in the bonding motifs of our materials. We observe a significant decrease in the relative amount of C═O, C—O, and C—N bonds in the hot-pressed materials, in comparison to the unpressed powder. Specifically, compared to the raw spirulina powder, the weakest (tested) bioplastic has 15% fewer C═O and 10% fewer C—O/C—N bonds while the strongest (tested) bioplastic has 33% fewer C═O and 31% fewer C—O/C—N bonds (FIG. 6A-C). Both pressed samples have higher amounts of C—C/C—H groups compared to the unpressed powder (7 and 18% higher respectively for the 60 and 140° C.) (FIG. 6A). The spirulina cells used in this study include 54.2-63.1 wt % protein as measured by elemental analysis (CHN), using a CHN Analyzer 2400 Model from PerkinElmer operating in combustion mode at 925° C. The protein content of spirulina can be calculated qualitatively as the product of the nitrogen content and an indirect conversion factor. The factor used most commonly was 6.25, however, quantitative measurements of protein content indicate that the use of this factor may result in overestimation of the protein content of most algae. In fact, Angell et al. propose that five may be a more accurate conversion factor for seaweeds (A. R. Angell, et al., J. Appl. Phycol. 2016, 28, 511). To take into account the uncertainty of qualitative, indirect conversion from nitrogen content, the protein content is presented as a range of compositions calculated using both customary and conservative conversion factors, 15% saccharidic carbohydrates and 15% acid-soluble phenolics as determined by high-performance liquid chromatography (HPLC), (J. L. Fredricks, H. Iyer, R. McDonald, J. Hsu, A. M. Jimenez, E. Roumeli, J. Polym. Sci. 2021, 59, 2878) 1.9-7.8% lipids, M. d. Oliveira, M. Monteiro, P. Robbs, S. Leite, Aquacult. Int. 1999, 7, 261; S. Bensehaila, A. Doumandji, L. Boutekrabt, H. Manafikhi, I. Peluso, K. Bensehaila, A. Kouache, A. Bensehaila, African J. Biotech. 2015, 14, 1649; K. Kusmiyati, A. Heratri, S. Kubikazari, A. Hidayat, H. Hadiyanto, Int. Energy J. 2020, 20, 611) and 1-10% PHA (S. S. Costa, A. L. Miranda, D. d. J. Assis, C. O. Souza, M. G. de Morais, J. A. V. Costa, J. I. Druzian, Algal Res. 2018, 33, 231).

While not wishing to be bound by any particular limitations, it is theorized that heat and pressure facilitate reactions of the C═O and C—O bonds at chain ends and pendant sites which result in the increased amount of C—C bonds measured in the spectra of hot-pressed samples. Therefore, distinct changes in the covalent bond makeup of the spirulina samples upon hot pressing in addition to the hydrogen bonding suggested by the IR spectra was observed. The data collectively suggest that the processing of spirulina powder with heat and pressure leads to changes in covalent bonding and enhances the secondary interactions between the biopolymers within the biomatter in addition to causing conformational changes (β-sheet formation) in the protein matrix. These changes together support the measured increases in the mechanical properties as the biomatter is processed at higher temperatures. The presence of PHA in spirulina may also contribute to the bonding of the bioplastics, but because of PHA's relatively low concentration and high melting point its contributions are likely minimal compared to those of the other biopolymers discussed above (S. S. Costa, et al. Algal Res. 2018, 33, 231).

Thermogravimetric analysis was conducted to examine the thermal stability of the bioplastics. The thermogravimetric analysis (TGA) was performed on a Discovery TGA 550, from TA Instruments. Samples of 13±4 mg of each material were subjected to heating from room temperature to 1000° C. at a heating rate of 10° C. min⁻¹ in a nitrogen gas flow of 25 μL min⁻¹. Differential Scanning calorimetry (DSC) was done on a Discovery 2500 DSC from TA Instruments, in hermetically sealed TZero aluminum pans. Each specimen went through two heating and cooling cycles each, at rates of 10° C. min⁻¹, with isothermal holds of 1 min between each cycle, from −75 to 200° C.

Analysis was conducted on unpressed, powdered spirulina and a pressed, well plasticized sample. As shown in FIGS. 8A-C, while the onset of degradation occurs at approximately the same temperature of 200° C., an interesting difference shows up at the beginning of the graph. Water evaporation is the expected mass loss at temperatures below 100-150° C. Indeed, we observe a mass loss of 8% for the spirulina powder and 2.5% for the pressed bioplastic up to 150° C. The powder loses significantly more mass at the beginning of the run up to approximately the onset of degradation. This indicates that the self-bonding process either helps retain water within the material by turning into a homogenous object with less surface area to evaporate water, or water is being used up in the self-bonding process, leaving less to be evaporated out. The first derivative of mass loss over time (DTG) shows that the main mass loss step starts at approximately 180° C. and shows insignificant difference between the powder and bioplastic, suggesting that the initiation of their thermal degradation coincides. Indeed, between approximately 200 and 300° C. the mass loss profiles overlap. However, the following steps of thermal degradation above 300° C. show distinct differences amongst the two cases. Both cases show a 3-step degradation profile, but the pressed sample has more smooth transitions between the mass loss steps. This suggest that degradation reactions happen at a different rate in the two materials, thereby confirming a major transformation in the way that the spirulina components are bonded after being compression molded.

### Example III

### Fabrication of Spirulina/Nanoclay Composites

Spirulina algae cells were procured from Nuts.com as Organic Spirulina. Nanoclay was Montmorillonite K 10 procured from Sigma Aldrich. An aqueous suspension of the as-received spirulina cells in a 1:10 w/w concentration was sonicated for 20 min using Fisher Scientific Model 505 probe sonicator, on an ice bath. After sonication, the dissociated biomatter suspension was freeze-dried using a Freezone lyophilizer from Labcono Corp. The pre-sonicated and freeze-dried dissociated spirulina powder was then mixed with the nanoclay powder using an Analog Vortex Mixer from VWR. The premixed powders were then subjected to a compression molding process on a TMAX-SYP-600 hot press from TMAXCN, using custom-made stainless-steel molds. These molds were loaded with 1 g of spirulina per sample to produce beams with lengths and widths of approximately 60 and 8 mm, respectively. Samples were curved at the ends with radii of approximately 3.5 mm.

After production, each sample was labeled and placed in a desiccation chamber for 24 hours. Once a specimen had reached at least 24 hours of desiccation, their thicknesses, widths, and masses were measured, and the samples were subjected to additional analysis via imaging and mechanical testing.

### Example IV

### Fabrication of Spirulina/Bacterial Cellulose Composites.

Spirulina algae cells were procured from Nuts.com as Organic Spirulina. Bacterial Cellulose was produced from a kombucha culture as described in J. L. Fredricks, M. Parker, P. Grandgeorge, A. M. Jimenez, E. Law, M. Nelsen, E. Roumeli, MRS Commun. 2022, 12, 394.

An aqueous suspension of the as-received spirulina cells in a 1:10 w/w concentration was sonicated for 20 min using Fisher Scientific Model 505 probe sonicator, on an ice bath. After sonication, the dissociated biomatter suspension was freeze-dried using a Freezone lyophilizer from Labcono Corp. BC sheets with dimensions of 40 mm by 1 mm were laid along the X-Y plane of the mold, in between pure spirulina powder, creating a layered structure that was hot pressed at 140° C./7 kN. The BC sheets made up 10 wt. % of the biocomposite.

After production, each sample was labeled and placed in a desiccation chamber for 24 hours. Once a specimen had reached at least 24 hours of desiccation, their thicknesses, widths, and masses were measured, and the samples were subjected to additional analysis via imaging and mechanical testing.

### Example V

### Fabrication of Spirulina/Sorbitol Bioplastics

Spirulina algae cells were procured from Nuts.com as Organic Spirulina. Sorbitol was purchased from Sigma Aldrich. An aqueous suspension of the as-received spirulina cells in a 1:10 w/w concentration was sonicated for 20 min using Fisher Scientific Model 505 probe sonicator, on an ice bath. After sonication, the dissociated biomatter suspension was freeze-dried using a Freezone lyophilizer from Labcono Corp. The pre-sonicated and freeze-dried dissociated spirulina powder was then mixed with the sorbitol powder were combined at the desired concentrations of 1, 5, 10, and 30 wt. % in sorbitol. The blended powders were then fed through a Scientific Process 11 Twin-Screw Extruder from Thermo Fisher, operating at 40 rpm, with a uniform temperature profile of 90° C., before being hot pressed at 80° C. and 7 kN, for 1 min. Once a homogenous powder was produced by the extruder, the powder was loaded into molds (typical size of the molds 8×60×1 mm³) and pressed at 80° C., 7 kN at sorbitol concentrations from 0% to 30%.

After production, each sample was labeled and placed in a desiccation chamber for 24 hours. Once a specimen had reached at least 24 hours of desiccation, the specimen's thicknesses, widths, and masses were measured, and the samples were subjected to additional analysis via imaging and mechanical testing.

### Example VI

### Comparative Mechanical Testing of Spirulina-Based Bioplastics

Three-point bend specimens of each bioplastic type were desiccated for 24 h at 23° C., before being tested on an AGS-X test frame from Shimadzu Scientific Instruments. A minimum of nine samples were tested for each composition at a 0.5% per second strain rate and 40 mm gauge length. Compression testing was performed using an Instron 4505 universal test frame with a 5500R upgrade. A 100 kN load cell was used. A minimum of five samples per testing direction were tested at 0.5% per second strain rate.

An AGS-X (10 kN) test frame, made by Shimadzu Scientific Instruments in Columbia, MD, USA, was used in a three-point bending configuration. All samples were tested at a 0.5% strain rate. The stress on a sample in three-point bending is calculated using Equation 3:

$${σ}_{f} = \frac{3 F L}{2 {bd}^{2}} , \qquad ( 3 )$$

where σ_{f} is the flexural stress at the outer surface at the midspan of the beam, F is the load at a point on the load-displacement curve, L is the support span of the test setup, b is the width of the specimen, and d is the depth of the specimen. This equation is appropriate for three-point bend specimens with a rectangular cross-section, which was the case with the samples used in this study.

As shown in FIG. 21A and FIG. 21B, the addition of 5% nanoclay increased average flexural strength of sonicated spirulina alone from 35.1±4.5 to 57.2±7.4 MPa (63% increase), an increase in work to fracture from 0.15±0.03 to 0.29±0.06 MJ m-3 (93% increase), and an increase in stiffness from 3.9±0.7 to 5.3±0.3 GPa (36% increase) over sonicated and freeze-dried spirulina without the nanoclay. The addition of bacterial cellulose provided significant strengthening and toughening. Specifically, the bacterial cellulose nanocomposite has an average toughness of 1.4±0.2 MJ m-3, which is 15× higher than the pure, untreated spirulina processed at the same conditions, while the strength reaches values as high as 42.25±9.06 MPa, 98.5% higher than pure spirulina.

Differential Scanning calorimetry (DSC) was used to study thermal events that materials undergo during heating and cooling cycles. Sorbitol was studied using a Discovery 2500 DSC from TA Instruments in New Castle, DE, USA. Hermetically sealed TZero aluminum pans were used to hold the sample and as a reference. Two heating and cooling cycles each were done at rates of 10° C./min, with isothermal holds of 1 minute between each cycle. The DSC experiment was run from −75° C. to 200° C. As sorbitol concentration increases, a gradual increase in strength and toughness is observed. The 5 and 10 wt. % sorbitol bioplastics have a 41.4% and 90.5% increased modulus, 45.9% and 136.4% increased strength, and 100% and 300% increased toughness compared to the neat spirulina, as shown in FIGS. 19A-B. At 30 wt. % sorbitol, the strength reaches 10.2±1.6 MPa and the toughness is 0.16±0.05 MJ m-3, marking increases of 3 and 16 times, respectively, compared to the pure spirulina control. The highest (tested) strain-to-break values (2.8%) are achieved at the maximum (tested) sorbitol concentration of 30 wt. %, showing a 2.4-fold increase over the pure spirulina. As shown in FIGS. 18A-18C, when sorbitol was introduced in the formulation, it melts and forms a co-matrix surrounding the cells which are bonded together without being disrupted.

The mechanical properties of spirulina/sorbitol samples pressed at 80° C./2 kN/1 min with varying concentrations of sorbitol are shown in FIGS. 19A-C. Interestingly, mechanical properties do not seem to change significantly up to 10% sorbitol, with the most significant changes showing at 30% sorbitol. In this study, higher concentrations of sorbitol were not processable because the sorbitol would flow out of the mold, pulling the spirulina with it and creating untestable samples. As indicated in FIG. 19, the samples showed marked improvements in toughness, strength, and elongation to break, but reductions in stiffness. The strength is shown to increase by about 2.4 times (from 4.18±0.60 to 10.24±1.57 MPa), while the toughness increases by an impressive 16 times (from 0.01±0.00 to 0.16±0.05 MJ/m³). The increases in strength indicate that the plasticizer assists in creating a uniform bulk material that is not able to be formed at the selected processing conditions without the presence of the plasticizer. This is supported by other mechanical property and morphological observations that at 80° C./2 kN the samples are loosely bonded, compacted powders rather than a fully self-bonded material. The presence of the additive above the concentration threshold of 5 wt % assists the formation of a cohesive bulk backbone in these processing conditions. The toughening and sustained extensibility before failure are known and expected effects from introducing plasticizers in bulk materials and are also observed in our case. We calculate the toughness as the area under the stress-strain curve. As shown in FIG. 19D, increasing amount of plasticizer leads to an increase in toughness as well as strength and strain before failure.

### Example VII

### Comparison of Spirulina Bioplastics to Commodity Plastics

As shown in FIG. 17A and FIG. 17B, elastic moduli between E=0.4 and 5.3 GPa and flexural strengths from σ=1.17 to 57.16 MPa place the bioplastics described herein within the performance space of commodity plastics. Neat PHBV typically has an elastic modulus around 1 GPa and strength below 20 MPa (E. Ten, L. Jiang, J. Zhang, M. P. Wolcott, Biocomposites 2015, 39, ISBN 978-1-78242-373-7). The elastic modulus and strengths of thermoplastic starch are typically low compared to other plastics, with E=0.003-1 GPa and σ=0.2-6 (Y. Zhang, C. Rempel, Q. Liu, Crit. Rev. Food Sci. Nutr. 2014, 54, 1353). The spirulina bioplastics perform similarly to most consumer-based plastics such as polyethylene (PE: E=0.25-1.25 GPa, σ=10-32 MPa), polypropylene (PP: E≈2 GPa, σ≈26 MPa), polystyrene (PS: ≈3 GPa, σ≈34 MPa), or Polyethylene terephthalate (PET: E≈2.3 GPa, σ≈55 MPa).

### Example VIII

### Flammability

Pure spirulina bars produced through the compression molding process described in Example I, self-extinguish in less than 1 s, producing a char. As shown in FIG. 22, after exposure to an open flame for 10 s, the spirulina bioplastic sample self-extinguished within less than 1 s and produced a char, while PLA combusted and melted leaving no solid residue.

Spirulina composites also improved the flammability of the resulting bioplastics. Composite bacterial cellulose and spirulina samples were created by mixing blended bacterial cellulose (BC) with water at a 0.8 wt % concentration. Spirulina powder (CS) was mixed in at various concentrations with respect to the amount of water in the slurry. The slurry was then loaded in molds and put in the freezer overnight. The resultant frozen materials were put in a freeze dryer for another night to get the desired rectangular molds.

Samples were prepared using the ratios shown in Table 2:

TABLE 2

| | | | |
|---|---|---|---|
| BC 89% | BC 44% | BC 14% | BC 7% |
| CS 11% | CS 56% | CS 86% | CS 93% |

The samples were then placed above a Bunsen burner such that the tip of the bright blue flame contacted the bottom the specimen during testing. The samples were tested by applying the flame to the hanging edge of the sample for 1 minute, after which the flame was removed. However, if the sample completely burned before 1 minute and the flame source was no longer contacting any portion of the remaining sample, the flame source would be removed earlier. As shown in FIG. 23, it was observed that even small amounts of spirulina (CS) slows down the burn rate and produces char in composite bioplastics such as spirulina/bacterial cellulose.

### Example IX

### Recyclability

Pure spirulina bioplastics were ground into a powder. The powder was subsequently incubated in ambient conditions for 24H before re-pressing under the hot-pressing conditions described above. As shown in FIG. 24, while there was gradual loss in strength over the course of six generations (starting at a strength of 29.5±2.4 MPa at generation 0, down to 22.2±4.6 MPa at generation 5). The stiffness remained consistent through the regeneration cycles, ranging from 3.5±0.7 to 3.2±0.5 GPa at the fourth regeneration.

### Example X

### Biodegradation:

The soil biodegradation study was performed by burying a total of 36 samples with dimensions 5×5×1 mm³ of each material in gardening soil which was regularly watered to keep wet. Every two weeks, a set of four samples was recovered to measure their mass loss after cleaning them in deionized water and drying them in an oven (60° C.), for 48 h to obtain the dry weight. PLA was chosen because it is a commonly used plastic that is considered compostable. A banana peel is a commonly available, purely natural material that degrades on a kitchen counter, let alone buried in soil.

As shown in FIG. 25B, advanced biodegradation was visually observed from the blending in of the samples with soil on day 111. This rate of degradation was at a rate comparable to the banana peels, with a rapid mass loss upon exposure to soil as shown in FIG. 26. During the first 5 weeks of incubation, both the banana peels and the bioplastics lose approximately 60% of their dry mass and about 80% after 22 weeks. Decelerating degradation kinetics may be calculated using Equation 1 as follows:

$$\frac{d α}{dt} = {k ( 1 - α )}^{n} \qquad ( 1 )$$

where α=Δm/m0 corresponds to the degree of conversion with Δm the mass variation and m0 the initial mass of the buried sample, gives a reasonable fit of our data. A least-square fitting provided values of n=2.89, k=0.29 and n=2.28, k=0.39 for banana and spirulina, respectively, with corresponding root-mean-square error values of 0.013 and 0.028.

### Example Clauses

1. A method of self-bonding biomatter, the method including:
mixing a composition including a biomatter to create a mixed composition; and
thermoforming the mixed composition into bioplastic by applying a pressing force and heat to the mixed composition for a time,
wherein one or more physical properties of the bioplastic are different than one or more physical properties of the mixed composition.
   2. The method of clause 1, wherein the biomatter includes at least one of Spirulina sp, alpha cellulose, glucomannan, powdered wood from Douglas fir, agai, coffee beans, dragon fruit, matcha powder, Chlorella vulgaris, Saccharina latissima, or Ulva sp.
   3. The method of clause 1 or 2, wherein the composition includes a plasticizer and/or a polymer.
   4. The method of clause 3, wherein the plasticizer includes about 0 to about 30 wt % of the composition.
   5. The method of clause 3 or clause 4, wherein the polymer includes a biodegradable polymer or a non-biodegradable polymer.
   6. The method of clause 5, wherein the biodegradable polymer includes at least one of poly(lactic acid) (PLA), polybutylene adipate terephthalate (PBAT), polyethylene oxide (PEO), polycaprolactone (PCL), poly(3-hydroxybutyrate-co-3-hydroxyvalerate) (PHBV), lignin, pine gum, bovine serum albumin (BSA), gluten, casein, lactoglobulin, or lysozyme.
   7. The method of clauses 1-6, wherein the temperature is about 140° C., the time is about five minutes, and the force is about 7 kN.
   8. The method of clauses 1-7, wherein the thermoforming includes heat extruding, hot-pressing, or injection molding.
   9. The bioplastic generated using the method of clauses 1-8.
   10. A bioplastic including biomatter, wherein the biomatter includes at least 50 wt % of the bioplastic, wherein the biomatter includes at least one of Spirulina sp, alpha cellulose, glucomannan, powdered wood from Douglas fir, agai, coffee beans, dragon fruit, matcha powder, Chlorella vulgaris, Saccharina latissima, or Ulva sp.
   11. The bioplastic of clause 10, further including a plasticizer and/or a polymer including about 0 to about 30 wt % of the bioplastic.
   12. The bioplastic of clauses 10 or 11, wherein a density of the bioplastic is in a range of about 0.8 to about 1.5 g/cm³.
   13. The bioplastic of clauses 10-12, wherein a density of the bioplastic is in a range of about 0.5 to about 1.5 g/cm³.
   14. The bioplastic of clauses 10-13, wherein a tensile strength of the bioplastic is in a range of about 15 to about 30 MPa.
   15. The bioplastic of clauses 10-14, wherein a modulus of elasticity of the bioplastic is in a range of about 1 to about 3.5 GPa.
   16. The bioplastic of clauses 10-15, wherein a flexural strength of the bioplastic is in a range of about 5 to about 30 MPa.
   17. The bioplastic of clauses 10-16, wherein a biodegradability of the bioplastic in soil is at least 15% loss of mass after 6 weeks.
   18. A biocomposite including biomatter and a polymer, wherein the biomatter includes about 0.01 wt % to about 99.99% wt % of the biocomposite and the polymer includes about 0.01 wt % to about 99.99 wt % of the biocomposite.
   19. The biocomposite of clause 18, wherein the biomatter includes at least one of Spirulina sp, alpha cellulose, glucomannan, powdered wood from Douglas fir, agai, coffee beans, dragon fruit, matcha powder, Chlorella vulgaris, Saccharine latissima, or Ulva sp.
   20. The biocomposite of clauses 19-20, wherein the polymer includes at least one of poly(lactic acid) (PLA), polybutylene adipate terephthalate (PBAT), polyethylene oxide (PEO), polycaprolactone (PCL), poly(3-hydroxybutyrate-co-3-hydroxyvalerate) (PHBV), lignin, pine gum, bovine serum albumin (BSA), gluten, casein, lactoglobulin, or lysozyme.

### CONCLUSION

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

This document cites various printed publications, articles, journals, patent documents, and other references. Each one of the references described is incorporated by reference herein in its entirety.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

We claim:

1. A method of self-bonding biomatter, the method comprising:
mixing a composition comprising a biomatter to create a mixed composition; and
thermoforming the mixed composition into bioplastic by applying a pressing force and heat to the mixed composition for a time,
wherein one or more physical properties of the bioplastic are different than one or more physical properties of the mixed composition.

2. The method of claim 1, wherein the biomatter comprises at least one of Spirulina sp, alpha cellulose, glucomannan, powdered wood from Douglas fir, agai, coffee beans, dragon fruit, matcha powder, Chlorella vulgaris, Saccharina latissima, or Ulva sp.

3. The method of claim 2, wherein the composition further comprises a plasticizer and/or a polymer.

4. The method of claim 3, wherein the plasticizer comprises about 0 to about 30 wt % of the composition.

5. The method of claim 4, wherein the polymer comprises a biodegradable polymer or a non-biodegradable polymer.

6. The method of claim 5, wherein the biodegradable polymer comprises at least one of poly(lactic acid) (PLA), polybutylene adipate terephthalate (PBAT), polyethylene oxide (PEO), polycaprolactone (PCL), poly(3-hydroxybutyrate-co-3-hydroxyvalerate) (PHBV), lignin, pine gum, bovine serum albumin (BSA), gluten, casein, lactoglobulin, or lysozyme.

7. The method of claim 1, wherein the temperature is about 140° C., the time is about five minutes, and the force is about 7 kN.

8. The method of claim 1, wherein the thermoforming comprises heat extruding, hot-pressing, or injection molding.

9. The bioplastic generated using the method of claim 1.

10. A bioplastic comprising biomatter, wherein the biomatter comprises at least 50 wt % of the bioplastic, wherein the biomatter comprises at least one of Spirulina sp, alpha cellulose, glucomannan, powdered wood from Douglas fir, agai, coffee beans, dragon fruit, matcha powder, Chlorella vulgaris, Saccharina latissima, or Ulva sp.

11. The bioplastic of claim 10, further comprising a plasticizer and/or a polymer comprising about 0 to about 30 wt % of the bioplastic.

12. The bioplastic of claim 10, wherein a density of the bioplastic is in a range of about 0.8 to about 1.5 g/cm³.

13. The bioplastic of claim 10, wherein a density of the bioplastic is in a range of about 0.5 to about 1.5 g/cm³.

14. The bioplastic of claim 10, wherein a tensile strength of the bioplastic is in a range of about 15 to about 30 MPa.

15. The bioplastic of claim 10, wherein a modulus of elasticity of the bioplastic is in a range of about 1 to about 3.5 GPa.

16. The bioplastic of claim 10, wherein a flexural strength of the bioplastic is in a range of about 5 to about 30 MPa.

17. The bioplastic of claim 10, wherein a biodegradability of the bioplastic in soil is at least 15% loss of mass after 6 weeks.

18. A biocomposite comprising biomatter and a polymer, wherein the biomatter comprises about 0.01 wt % to about 99.99% wt % of the biocomposite and the polymer comprises about 0.01 wt % to about 99.99 wt % of the biocomposite.

19. The biocomposite of claim 18, wherein the biomatter comprises at least one of Spirulina sp, alpha cellulose, glucomannan, powdered wood from Douglas fir, agai, coffee beans, dragon fruit, matcha powder, Chlorella vulgaris, Saccharine latissima, or Ulva sp.

20. The biocomposite of claim 18, wherein the polymer comprises at least one of poly(lactic acid) (PLA), polybutylene adipate terephthalate (PBAT), polyethylene oxide (PEO), polycaprolactone (PCL), poly(3-hydroxybutyrate-co-3-hydroxyvalerate) (PHBV), lignin, pine gum, bovine serum albumin (BSA), gluten, casein, lactoglobulin, or lysozyme.
